(19) United States
(12) Patent Application Publication
(10) Pub. No.: US 2017/0011313 A1
(43) Pub. Date: Jan. 12, 2017

(54) SYSTEMS AND METHODS FOR DETERMINING CONTRACT CLAUSES

(71) Applicant: The Boeing Company, Chicago, IL (US)

(72) Inventors: Oliver Pochert, White Salmon, WA (US); Timothy Hetzler, White Salmon, WA (US)

(21) Appl. No.: 14/791,809

(22) Filed: Jul. 6, 2015

(51) Int. Cl. G06Q 10/06; G06F 17/27; G06F 3/0484; G06F 3/0482

(52) U.S. Cl. CPC G06Q 10/063; G06F 3/0482; G06F 17/2705; G06F 3/0484; G06Q 10/0635

(57) ABSTRACT

A contract tool can determine the list of candidate contract clauses based on input from a user. The contract tool can determine the list of candidate contract clauses based on a multipart narrowing process. Once a contract is identified, the contract tool can retrieve any contract clauses that are relevant to the contract. In the next stage of the multipart narrowing, the contract tool can to determine the candidate contract clauses, from the retrieved contract clauses, based on conditions that define the applicability of a contract clause to the sub-contract or purchase order. The list of candidate contract clauses can be provided to the user.

### BACKGROUND

When dealing in procurement, for example governmental procurement, there are certain requirements imposed upon a company to prove all players in the supply chain are doing their due diligence. Part of the due diligence, when contracting with a company, is to provide a list of clauses the company must adhere to during the life of the contract. In turn, the company, contracting with the government, is required to flow certain clauses from the governmental contract to subcontractors and suppliers. For example, when a purchasing agent (PA) creates a purchase order (PO), the PA needs to determine which clauses, from the subject contract, need to be sent to the supplier with the PO. When dealing with multiple contracts from the government, there will be a unique set of contract clauses for each contract.

This causes several issues in the procurement process. First, there are about a thousand Federal Acquisition Regulations (FAR) and Defense Federal Acquisition Regulations (DFAR) clauses the government may use when contracting with a company. Due to the amount of contract clauses, employees of the company cannot easily remember or understand the numerous clauses. Second, the FAR and DFAR are constantly changing, thereby making it difficult to track changes in the requirements. Third, each clause is applicable only under certain circumstances. To comply with governmental requirements, only the applicable clauses need to be flowed to the supplier or sub-contractor. Thus, there is a need for systems and methods that efficiently and accurately determine contract clauses for sub-contracts and purchases orders tied to contracts, for example, governmental contracts.

### SUMMARY

Aspects of the present disclosure concern a method that includes determining, based on a first set of data identifying a governmental contract, a plurality of contract clauses that are applicable to the governmental contract. The first set of data is received from a user. The method also includes receiving, from the user, a second set of data identifying parameters of at least one of a sub-contract and purchase order under the governmental contract. The second set of data comprises one or more of a purchase order number, a value of the sub-contract, and a supplier name for the purchase order. Further, the method includes determining, based on the second set of data, a first set of contract clauses from the plurality of the contract clauses that are applicable to the at least one of a sub-contract and purchase order. Additionally, the method includes determining, by one or more processors based on the first set of contract clauses, one or more questions for the user. The one or more questions determine an applicability of one or more contract clauses in the first set of contract clauses. The method also includes determining, based on answers to the one or more questions, a list of contract clauses from the first set of contract clauses, and providing, to the user, the list of contract clauses for the at least one of a sub-contract and purchase order.

Additionally, aspects of the present disclosure concern a system that includes one or more memory devices storing instructions, and one or more processors coupled to the one or more memory device. The one or more processors can be configured to execute the instructions to perform a method. The method includes determining, based on a first set of data identifying a contract, a plurality of contract clauses that are applicable to the contract. The first set of data can be received from a user. The method also includes prompting the user to provide a second set of data identifying parameters of at least one of a sub-contract and purchase order under the contract. Further, the method includes determining, based on the second set of data, a first set of contract clauses from the plurality of the contract clauses that are applicable to the at least one of a sub-contract and purchase order. Additionally, the method includes prompting the user to provide answers to one or more questions. The one or more questions can determine an applicability of one or more contract clauses in the first set of contract clauses. The method also includes determining, based on the answers to the one or more questions, a list of contract clauses from the first set of contract clauses, and providing, to the user, the list of contract clauses for the at least one of a sub-contract and purchase order.

Additionally, aspects of the present disclosure concern a non-transitory computer readable medium storing instructions that cause one or more processor to perform a method. The method that includes determining, based on a first set of data identifying a contract, a plurality of contract clauses that are applicable to the contract. The first set of data can be received from a user. The method also includes receiving, from the user, a second set of data identifying parameters of at least one of a sub-contract and purchase order under the contract. Further, the method includes determining, based on the second set of data, a first set of contract clauses from the plurality of the contract clauses that are applicable to the at least one of a sub-contract and purchase order. Additional, the method includes determining, by one or more processors based on the first set of contract clauses, one or more questions for the user. The one or more questions can determine an applicability of one or more contract clauses in the first set of contract clauses. The method also includes determining, based on answers to the one or more questions, a list of contract clauses from the first set of contract clauses, and providing, to the user, the list of contract clauses for the at least one of a sub-contract and purchase order.

### BRIEF DESCRIPTION OF THE FIGURES

FIG. 1 illustrates an example of a network environment and computer system that includes a contract tool, according to various aspects of the present disclosure.

FIGS. 2A and 2B illustrate an example of a process of determining contract clauses, according to various aspects of the present disclosure.

FIGS. 3A-3F illustrates examples of forms provided by the contract tool, according to various aspects of the present disclosure.

FIG. 4 illustrates an example of a process of tracking deadline, according to various aspects of the present disclosure.

FIG. 5 illustrates an example of a process of assessing and mitigating risk, according to various aspects of the present disclosure.

FIG. 6 illustrates an example of a process of updating the contract tool, according to various aspects of the present disclosure.

FIG. 7 illustrates an example of a hardware configuration for a computer device, according to various aspects of the present disclosure.

### DETAILED DESCRIPTION

For simplicity and illustrative purposes, the principles of the present teachings are described by referring mainly to examples of various implementations thereof. However, one of ordinary skill in the art would readily recognize that the same principles are equally applicable to, and can be implemented in, all types of information and systems, and that any such variations do not depart from the true spirit and scope of the present teachings. Moreover, in the following detailed description, references are made to the accompanying figures, which illustrate specific examples of various implementations. Logical and structural changes can be made to the examples of the various implementations without departing from the spirit and scope of the present teachings. The following detailed description is, therefore, not to be taken in a limiting sense and the scope of the present teachings is defined by the appended claims and their equivalents.

According to aspects of the present disclosure, a contract tool can determine and recommend candidate contract clauses for a sub-contract and/or purchase order for a prime contract, for example, a governmental contract. The candidate contract clauses can include those contract clauses that are relevant and required for a specific sub-contract and/or purchase order. The contract tool can communicate with a repository storing clauses associated with a prime contract. Once a prime contract is selected, the contract tool can retrieve the contract clauses applicable to the prime contract. To determine the relevant and required clauses, the contract tool can receive, from a user, data that represents parameters of the sub-contract and/or purchase order, for example, the value of the sub-contract and/or purchase order, identity of the sub-contract and/or purchase order, supplier associated with the sub-contract and/or purchase order, etc. The contract tool can determine a sub-set of contract clauses, from the retrieved clauses, that are relevant to the parameters supplied by the user. To further focus the candidate contract clauses, the contract tool can maintain a bank questions that determine the relevance of certain clauses. The contract tool can determine a final list of candidate clauses by applying the answers to the questions to further narrow the contract clauses.

Additionally, the contract tool can automatically generate the bank of questions based on current versions of known contract clauses. When contract clauses are updated by the contracting agency, for example the federal government, the contract tool can retrieve the updates to the contract clauses, and revise bank of questions or generate new questions.

By narrowing the possible contract clauses through a multi-stage process, the contract tool can determine and provide only those contract clauses that are relevant to a purchase order or sub-contract. By reducing the user interaction to only providing data about the contract and answering simple questions, a user can easily identify the appropriate contract clauses without learning the specifics of each clause. Additionally, because the contract tool automatically updates based on changes to the contract clauses, the contract tool can accurately provide the relevant contract clauses as governmental regulations change over time.

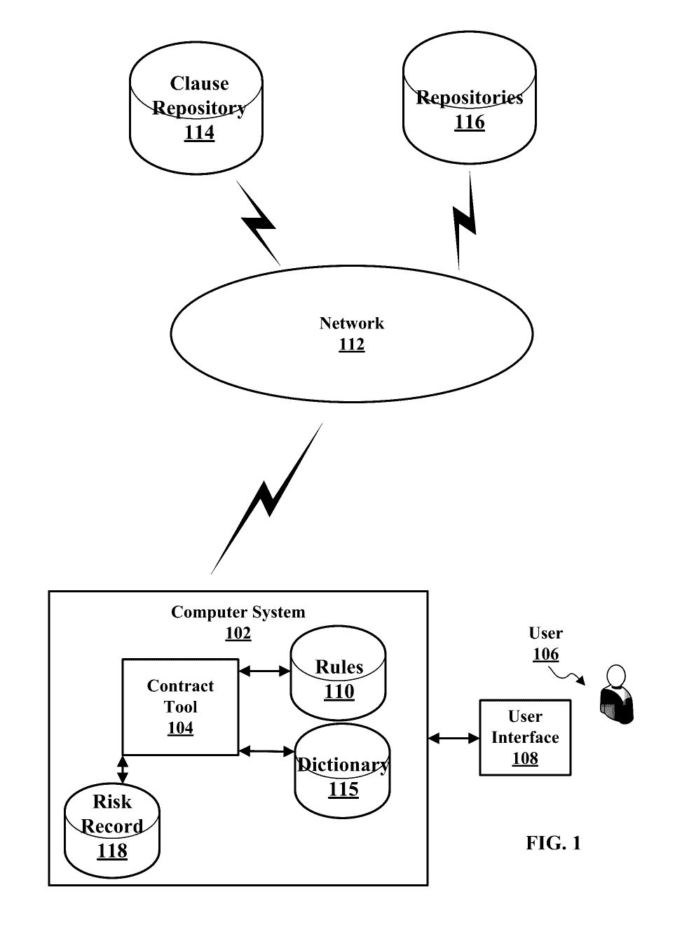

FIG. 1 illustrates a network environment 100 in which contracts clauses can be automatically determined, according to aspects of the present disclosure. While FIG. 1 illustrates various components contained in the network environment 100, FIG. 1 illustrates one example of a network environment and additional components can be added and existing components can be removed.

As illustrated in FIG. 1, the network environment 100 includes a computer system 102. The network environment 100 can represent the computer systems and network hardware of public or private entities, such as governmental agencies, individuals, businesses, partnerships, companies, corporations, etc., utilized to support the entities. The computer system 102 can be any type of conventional computer systems that is operating in the network environment 100 or supporting the network environment 100. For example, the computer system 102 can include various types of servers, such as file servers, web servers, application servers, database servers, email servers and the like, that provide services within the network environment 100. Likewise, for example, the computer system 102 can include laptop computers, desktop computers, tablet computers, mobile phones, and the like used by the personnel of the entities.

Additionally, for example, the network environment 100 can include other hardware and computer systems that support the network environment 100. For example, the network environment 100 can include gateways, routers, wireless access points, firewalls, and the like that support any type of communications networks to allow the computing systems in the network environment 100 to communicate. In any of the examples, the computer systems, including the computer system 102, in the network environment 100 can include hardware resources, such as processors, memory, network hardware, storage devices, and the like, and software resources, such as operating systems (OS), application programs, and the like.

According to aspects of the present disclosure, the computer system 102 can be configured to execute a contract tool 104. The contract tool 104 can be configured to automatically determine a list of candidate contract clauses to be included in a contract, purchase order, and the like. In some aspects, the contract tool 104 can be configured to determine a list of candidate contract clauses to be included in a sub-contract and/or a purchase order (POs) for a suppler providing services or goods to a prime contract, for example, a governmental contract. The contract tool 104 can be configured as a software program that is capable of being stored on and executed by the computer system 102. The contract tool 104 can be written in a variety of programming languages, such as JAVA, C++, Python code, Visual Basic, hypertext markup language (HTML), extensible markup language (XML), and the like to accommodate a variety of operating systems, computing system architectures, etc.

The contract tool 104 can be configured to automatically determine the list of candidate contract clauses based on input from a user 106. To receive input and output results to the user 106, the contract tool 104 can be configured to generate and provide a user interface 108. The user interface 108 can be any type of command line and/or graphical user interface (GUI) that allows the user 106 to interact with the contract tool 104. The contract tool 104 can be configured to provide, via the user interface 108, controls, forms, reports, etc., to allow the user 106 to interact with the contract tool 104 and perform the processes described herein.

In aspect, the contract tool 104 can be configured to determine the list of candidate contract clauses based on a multipart narrowing process. To begin the process of determining the list of candidate contract clauses, the contract tool 104 can be configured to receive, from the user 106, an identification of a contract. For example, the identification of the contract can include a contract number. Once the contract is identified, the contract tool 104 can be configured retrieve any contract clauses that are relevant to the contract.

In aspects, the contract tool 104 can be configured to retrieve, via a network 112, the contract clauses from a clause repository 114. The network 112 can be any type of network whether public or private. The clause repository 114 can be any type of computer system that stores information about contracts. In some aspect, for example, the clause repository 114 can include a governmental contracting site such as Federal Acquisition Regulation Site (FARSite, http://farsite.hill.af.mil/). While the FARSite is one example, the contract tool 104 can be configured to communicate with any repository that contains contract clauses. While the contract tool 104 can communicate with the clause repository 114, in some aspects, the contract tool 104 can be configured to store one or more of the contract clauses locally once retrieved from the clause repository 114.

In aspects, in the next stage of the multipart narrowing, the contract tool 104 can be configured to determine the candidate contract clauses, from the retrieved contract clauses, based on conditions that define the applicability of a contract clause to the sub-contract and/or PO. Many contract clauses include one or more conditions that must be satisfied before the contract clause applies to the sub-contract and/or PO. For example, a contract clause may only be applicable to specific suppliers or entities, to particular sub-contracts and/or POs, and to particular values of the sub-contract and/or PO. Additionally, many contract clauses may only be applicable in specific circumstances. For example, if an item being purchase contains specialty metals, certain contract clauses may need to be flowed to the supplier.

In aspects, to determine the candidate contract clauses, the contract tool 104 can be configured to maintain one or more rules 110. The rules 110 can include one or more conditions that define the applicability of a particular contract clause. In some aspects, the conditions can be associated with parameters of the sub-contract and/or PO. For example, the parameters can include data identifying specific suppliers or entities (e.g. suppler name), data identifying particular sub-contracts and/or POs (e.g. PO or sub-contract number), and data identifying particular values of the sub-contract and/or PO (e.g. dollar value). In some aspects, the conditions can be associated with questions that can be answered by the user 106. For example, the contract tool 104 can be configured to determine and present questions to the user 106 that determine whether the condition is satisfied. In some aspects, the questions can be in the form of “Yes” or “No” questions.

For example, in governmental contracting, the contract clauses that are applicable to a sub-contract or a PO associated with a prime contract are based on the specific contract, the value of the contract (in dollars), the supplier who is the subject of the PO, details of the supplier, conditions of the performance of the contract, and the like. The contract tool 104 can be configured to maintain rules 110 that govern the determination of the list of candidate contract clauses. Tables 1, 2, and 3, located at the end of this disclosure, show examples of the rules 110 that can be utilized by the contract tool 104.

For example, Table 1 illustrates a complete list of contract clauses for governmental contracting and conditions that define when the FAR contract clauses are applicable. As shown in Table 1, column 1 includes the contract clause number. Column 2 includes the text of the contract clause. Column 3 includes a condition when the contract clause is applicable, for example, a question that defines the applicability of the contract clause, a specific value threshold, or if the contract clause is always applicable. Table 2 shows examples of FAR contract clauses that are applicable based on the value of the contract. Column 1 includes the contract clause number. Column 2 includes the text of the contract clause. Column 3 includes the value threshold (in dollars) when the associated contract clause because applicable. Table 3 illustrates a bank of questions and the applicable contract clauses. As illustrated, Column 1 can include the question numbers. Column 2 can include the text of the question to present to the user 106. Column 3 can include the clause that is applicable if the question is answered “Yes.”

In aspects, the contract tool 104 can generate the rules 110 from the contract clauses. The contract tool 104 can parse the language to the contract clauses in order to determine the rules for applicability of the contract clauses and the questions for the user 106. The contract tool 104 can maintain a dictionary 115 of terms to search for in each parsed clause. The dictionary 115 can include terms such as dollar signs ($), keywords, conditional phrases, explicit applicability sections in the clause, etc. Once the contract tool 104 identifies terms or phrases, the contract tool 104 can generate the rules for applicability of the contract clauses and the questions for the user 106.

The contract tool 104 can also be configured to communicate with repositories 116 via the network 112. The repositories 116 can store other information that can be used by the contract tool 104 during the processes described below. For example, the repositories can store additional data specific to the suppler, prime contractor, sub-contractor, etc.

The contract tool 104 can also be configured to assess the risk of contract clauses and suggests terms and conditions to mitigate the risk of the contract clauses. The contract tool 104 can be configured to examine each contract clause and determine a risk associated with each contract clause. The contract tool 104 can maintain the risk record 118 that maps contract clauses to a base risk score. The risk record 118 can be pre-generated by the user 106 of the contract tool 104. The contract tool 104 can be configured to generate the risk record 118. For example, the contract tool 104 can parse contract clauses and search for words to denote risk. The terms can include, example, “terminate” “liable” “inspect” etc. that indicate a high risk. If a term exists, the contract tool 104 can increase the base score by a predetermined value that corresponds to the term in the contract clause. For example, if a contract clause includes a term “liable,” the contract tool 104 can determine to increase the base risk score by a predetermined value of “30.”

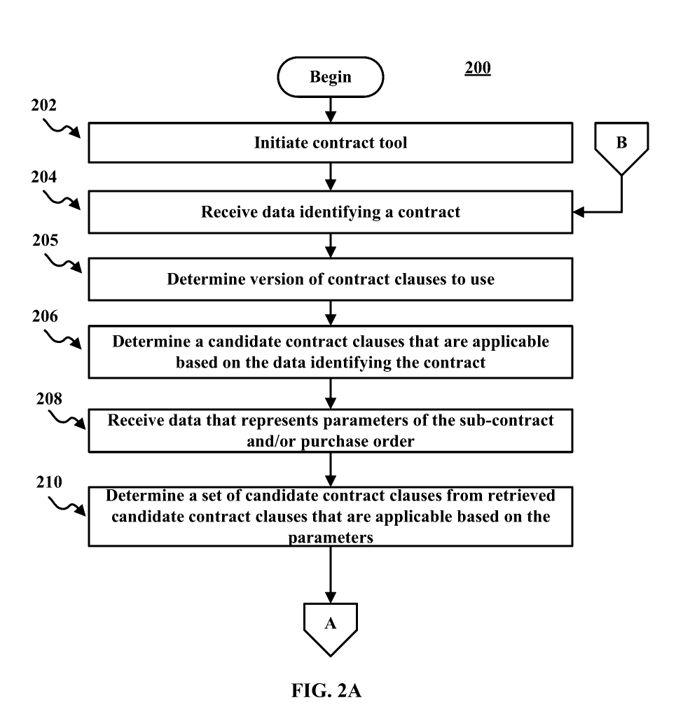

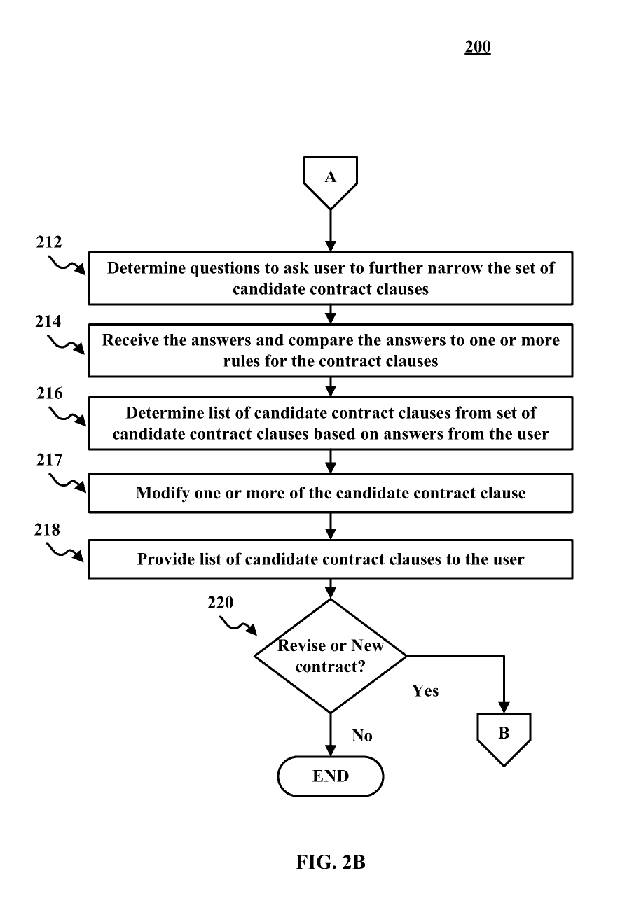

FIG. 2 illustrates one example of a process 200 for determining contract clauses, according to aspects of the present disclosure. While FIG. 2 illustrates various stages that can be performed, stages can be removed and additional stages can be added. Likewise, the order of the illustrated stages can be performed in any order.

After the process begins, in 202, the contract tool can be initiated. For example, the user 106 can initiate execution of the contract tool 104 on the computer system 102. Once initiated, the contract tool 104 can provide the user interface 108 to the user 106. The user interface 108 can allow the user 106 to enter details of the contract in order to determine candidate contract clauses that are relevant to a sub-contract and/or PO.

In 204, the contract tool can receive data that identifies a contract. For example, the contract tool 104 can provide, via the user interface 108, a form that allows the user 106 to enter the data that identifies the contract. In some aspects, the contract tool 104 can retrieve the data that identifies the contract from the repositories 116. For example, the user 106 can enter the contract number of the contract, which is the subject of a sub-contract and/or PO.

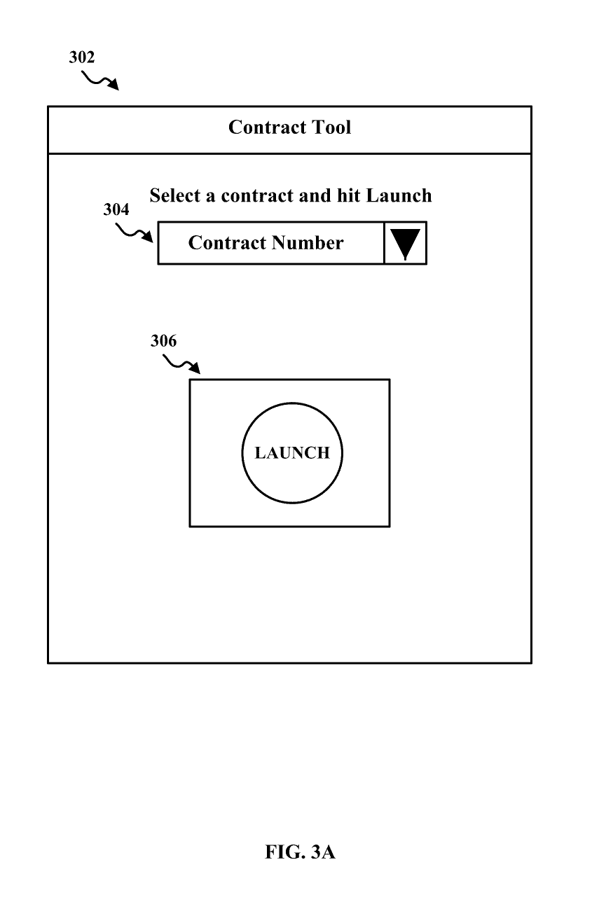

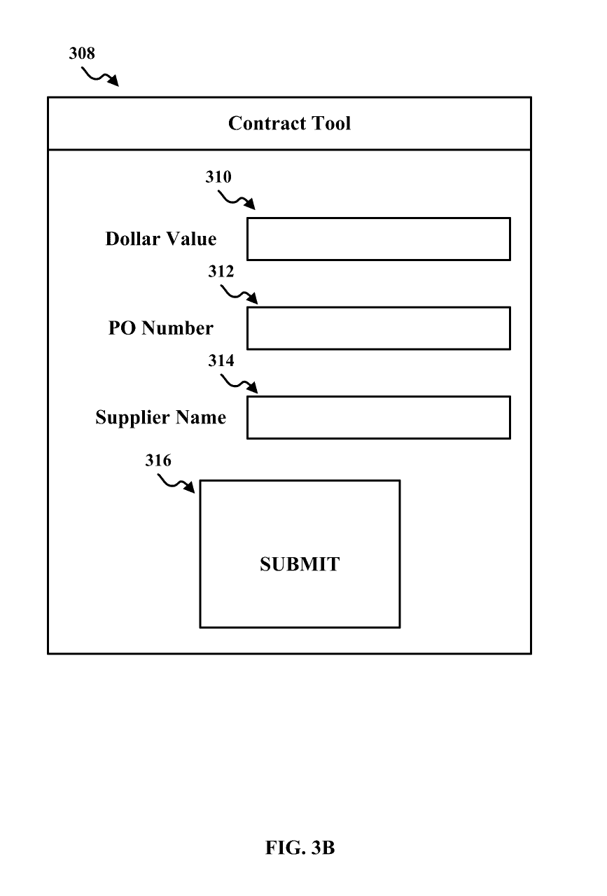

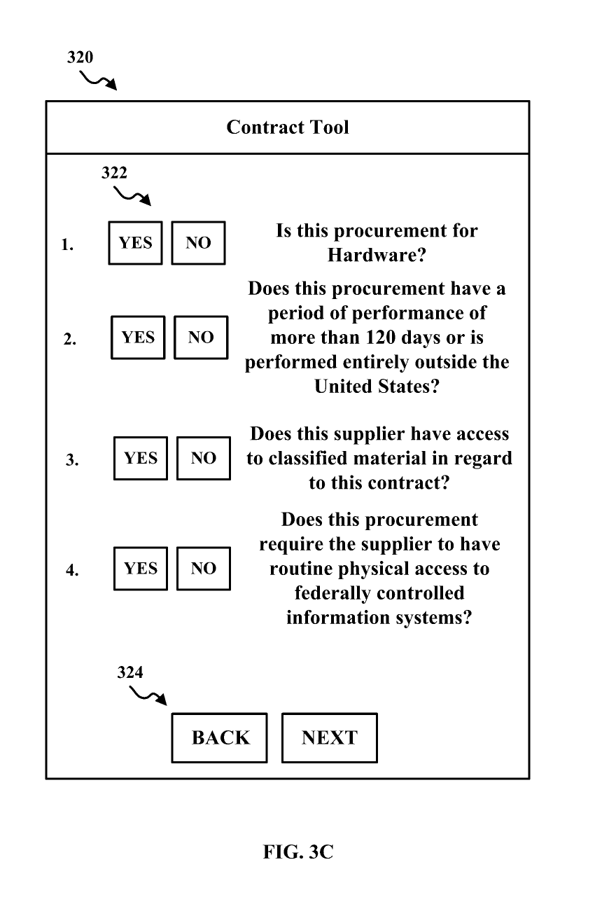

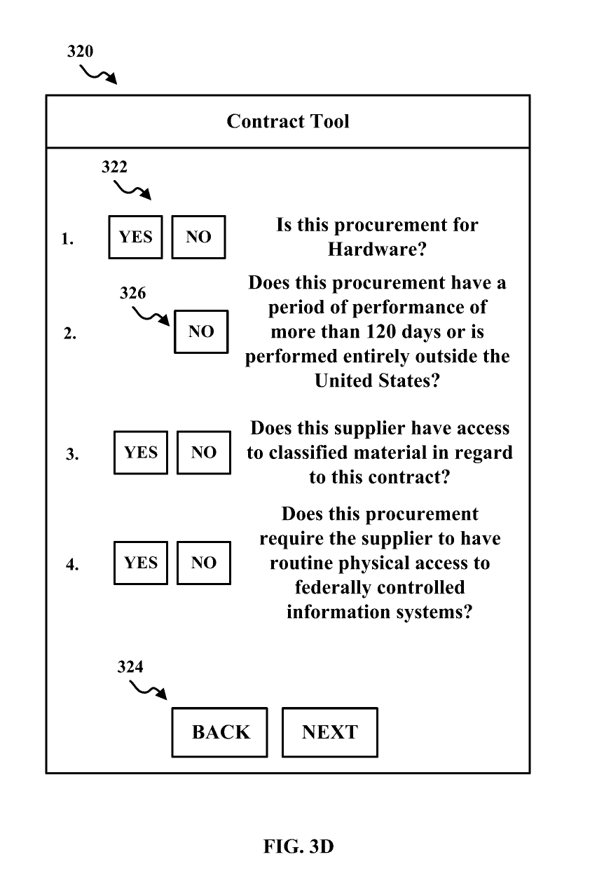

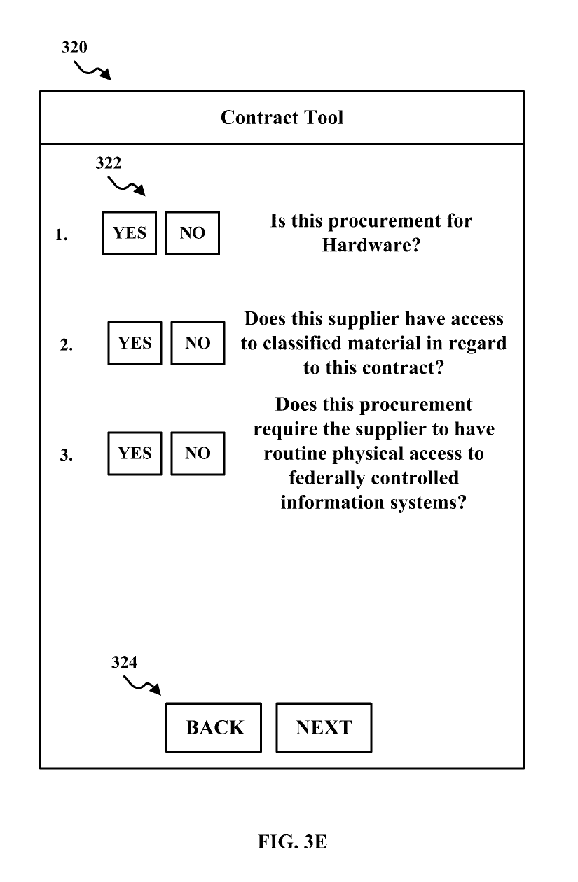

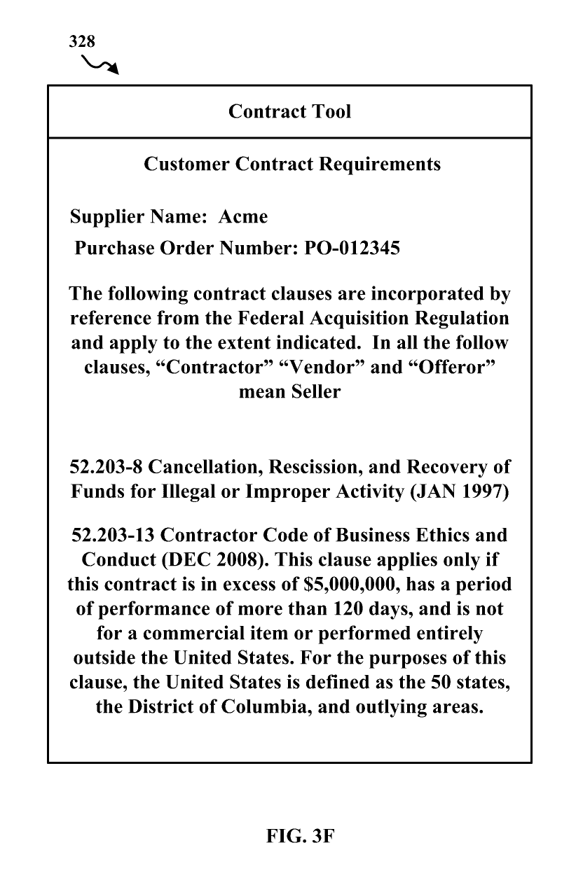

FIG. 3A illustrates one example of a form 302 to receive the data that identifies the contract. As illustrated in FIG. 3A, the form 302 can include a field 304 that allow the user 106 to enter a contract number. In some aspects, the field 304 can be configured as a drop-down menu that allows the user 106 to select a known contract number. In some aspects, the field 304 can be a fillable field that allows user 106 to enter a contract number. Once the contract number is selected, the user 106 can select a widget 306 to begin the process of determining candidate clauses. The widget 306 can be a button, as illustrated, or any other type of widget that can be selected by the user 106.

In 205, the contract tool can determine a version of the contract clauses to use. Contract clauses may be updated and changed over time. The appropriate contract clauses to use may depend on then the contract was executed. The contract tool 104 can determine the version of the contract clauses to use based on the contract number or from information contained in the repositories 116.

In 206, the contract tool can determine candidate contract clauses that are applicable based on the data identifying the contract. For example, the contract tool 104 can contract the clause repository 114. Based on the contract number, the contract tool 104 can retrieve any contract clauses that are applicable to the contract number. For instance, the contract tool 104 can connect with a public repository such as Federal Acquisition Regulation Site (FARSite, http://farsite.hill.af.mil/) via the Internet and retrieve clauses associated with the contract number.

In some aspects, the contract tool 104 can further filter the candidate contract clauses based on details of parties of the contract, the sub-contract and/or PO. For example, the contract tool 104 can determine details of the supplier such as specific industry, size of business (e.g. small business), and other factors (minority owned, veteran owned), location, etc. The contract tool 104 can further filter the clauses based on the details of the supplier. The details of parties of the contract, the sub-contract and/or PO can be provided by the user 106. The contract tool 104 can also retrieve the details from the repositories 116.

In 208, the contract tool can receive data that represents parameters of the sub-contract and/or PO. For example, the contract tool 104 can provide, via the user interface 108, a form that allows the user 106 to enter the data that represents the parameters of the sub-contract and/or PO. For example, the user 106 can enter data such as an identification of the supplier, the value of the contract, sub-contract and/or PO, and the number of the PO.

FIG. 3B illustrates one example of a form 308 for entering the data that represents the parameters of the sub-contract and/or PO. As illustrated, the form 308 can include fields 310, 312, and 314 for entering the value of the sub-contract and/or PO, the PO number, and the supplier subject to the PO, respectively. The form 308 can also include a widget 316. The form 308 can submit the data entered to the contract tool 104 once the widget 316 is selected. In some aspects, the contract tool 104 can obtain one or more of the parameters from the repositories 116.

In 210, the contract tool can determine a set of candidate contract clauses, from retrieved candidate contract clauses, that are applicable based on the parameters. For example, the contract tool 104 can compare the parameters to the rules 110. Based on the comparison, the contract tool 104 can determine a set of candidate contract clauses in which the parameters satisfy conditions of the rules 110.

For instance, in the governmental contracting example, the contract tool 104 can retrieve the Tables 1 and 2, described herein, from the rules 110. The contract tool 104 can compare the data entered by the user 106 to determine which clauses meet the conditions of the Tables 1 and 2 based on the data entered by the user 106. For example, the contract tool 104 can search the Table 1 and determine any clauses that are applicable to any sub-contract and/or PO. Likewise, for example, the contract tool 104 can search the Table 2 and determine any clauses that are applicable based on the value of the contract entered by the user 106. As seen in the Table 2, only certain clauses are applicable if the sub-contract and/or PO is above a given dollar amount. The contract tool 104 can select the clauses that are applicable based on the value of the sub-contract and/or PO entered by the user 106.

In some aspects, the rules 110 can be generated prior to initiation of the contract tool 104. In some aspects, the contract tool 104 can generate the rules 110 in real time as the contract tool 104 is performing the processes described in FIGS. 2A and 2B.

In 212, the contract tool can determine questions to ask user to further narrow the set of candidate contract clauses and provide the questions to the user. For example, the contract tool 104 can maintain, in the rules 110, a set of questions to that determine the applicability of contract clauses. The contract tool 104 can provide, via the user interface 108, one or more forms that allow the user 106 to answer the questions.

For instance, in the governmental contracting example, the contract tool 104 can retrieve the Table 3, described herein, from the rules 110. The contract tool 104 can retrieve one or more of the questions for inclusion in the form provided to the user 106. In some aspects, the contract tool 104 can retrieve all the questions for the user 106 to answer. In some aspects, the contract tool can retrieve only the questions relevant to clauses still in the set of candidate contract clauses. For example, the contract tool 104 can examine Column 3 to determine if any of the contract clauses are not included in the set of candidate clauses and not retrieve the associated questions.

In some aspects, the rules 110 can be generated prior to initiation of the contract tool 104. In some aspects, the contract tool 104 can generate the rules 110 in real time as the contract tool 104 is performing the processes described in FIGS. 2A and 2B.

FIG. 3C illustrates an example of a form 320 for providing the questions to the user 106. As illustrated, the form 320 can include an entry for each question to be provided to the user 106. Each entry includes widgets 322. The widgets 322 allow the user 106 to provide the appropriate answer to the question. The form 320 also includes widgets 324 for submitting the answers to the questions to the contract tool 104. The contract tool 104 can provide multiple version of form 320 to cover all the questions to be presented to the user 106.

FIG. 3D illustrates another example of a form 320 in which one or more of the questions have been answered by previous determinations made by the contract tool 104. For example, based on the contract number or parameters entered, the contract tool 104 can determine that the answer to a particular question. As illustrated, the contract tool 104 can include the answered question and can include a field 326 that indicates the answer that was previously determined.

FIG. 3E illustrates another example of a form 320 in which one or more of the questions are excluded that are not applicable. As illustrated, the contract tool 104 can remove one or more questions that cover contract clauses that are no longer in the set of candidate contract clauses (compared to form 320 illustrated in FIG. 3C).

In 214, the contract tool can receive answers and can compare the answers to one or more rules for the contract clauses. For example, the contract tool 104 can receive the answers from the one or more forms provided to the user 106. The contract tool 104 can then compare the answers to the conditions in the rules 110.

For instance, in the governmental contracting example, the contract tool 104 can identify the questions numbers, which were answered “yes.” The contract tool 104 can examine Table 3 and determine which contract clauses are associated with “yes.” The contract tool 104 can determine to include the contract clauses that are associated with questions answered “yes” and exclude the contract clauses associated with questions answered “no.”

In 216, the contract tool can determine the list of candidate contract clauses from set of candidate contract clauses based on the answers from the user. For example, the contract tool 104 can determine the list of candidate contract clauses are the contract clauses remaining after the narrowing process in stages 206-214.

In 217, the contract tool can modify one or more of the candidate contract clause. For example, the contract tool 104 can parse one or more of the candidate clauses to determine whether any of the contract clauses can or need to be modified for a specific sub-contract/PO. The contract tool 104 can parse the clauses to identify language that needs to be completed or generic language that needs to be tailored to a specific sub-contract/PO. Additionally, the contract tool 104 can modify contract clauses based details of a specific supplier, sub-contractor, etc.

In 218, the contract tool can provide list of candidate contract clauses to the user. For example, the contract tool 104 can provide, via the user interface 108, one or more reports that include the list of candidate contract clauses. The one or more reports can also include additional information such as the contract number, legal statements, and one or more of the parameters entered by the user 106.

FIG. 3F illustrates one example of a report 328 that can provide the list of candidate contract clauses. As illustrated in FIG. 3F, the report 328 can include the name of the supplier and the PO number. The contract tool 104 can utilize the information provided by the user 106 as the name of the supplier and the PO number. The report 328 can also include various legal statements 332. The contract tool 104 can maintain a repository of legal statements to include in the report 328. The report 328 can also include the list 334 of list of candidate contract clauses.

In 220, the contract tool can determine if the user desires to revise list of candidate clauses or determine a list of candidate clauses. If the user 106 desires to continue, the contract tool 104 can return to stage 204. Otherwise, the contract tool 104 can end the process or return to any point.

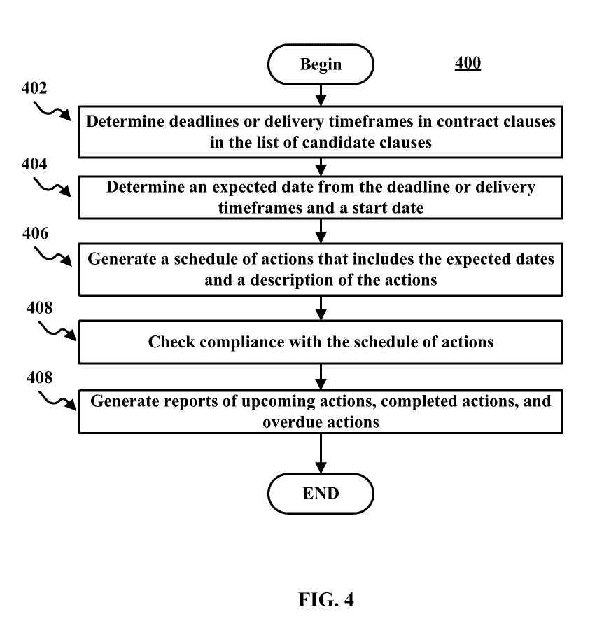

According to aspects, the contract tool 104 can be configured to perform other processes related to sub-contract and/or PO and the list of candidate clauses. FIG. 4 illustrates one example of a process 400 for identifying and tracking deadlines or delivery dates in the list of candidate clauses, according to aspect of the present disclosure. While FIG. 4 illustrates various stages that can be performed, stages can be removed and additional stages can be added. Likewise, the order of the illustrated stages can be performed in any order.

Once the process begins, in 402, the contract tool can determine deadlines or delivery timeframes in contract clauses in the list of candidate clauses. The contract tool 104 can be configured to parse the contract clauses in the list of candidate clauses and search for terms that indicate deadlines. For example, the terms can include “delivery,” “days,” “months,” “date,” etc.

In 404, the contract tool can determine an expected date from the deadline or delivery timeframes and a start date of the sub-contract and/or PO. The contract tool 104 can determine a start date on which the sub-contract and/or PO begins or expected to begin. Based on the start date, the contract tool 104 can calculate an expected date for the contract clauses. The contract tool 104 can receive the expected start date from the user 106 or retrieve the expected start date from the repositories 116.

For example, the contract tool 104 can parse a particular contract clause and determine that the particular contract clause includes delivery of a component within “30 days.” The contract tool 104 can determine that the sub-contract and/or PO has a start date of Jun. 1, 2015. Based on the delivery timeframe and the start date, the contract tool 104 can calculate that the expected date of delivery is Jul. 1, 2015.

In 406, the contract tool can generate a schedule of actions that includes the expected dates and a description of the actions. The contract tool 104 can generate the record from the expected date and the terms from the contract clauses. For instance in the above example, the contract tool 104 can generate a schedule that indicates delivery of components by Jul. 1, 2015.

In 408, the contract tool can check compliance with the schedule of actions. The contract tool 104 can compare the schedule of action to the current date and a record of actions that have been completed. The contract tool 104 can receive the record of actions completed from the user 106 or retrieve the record of action completed from the repositories 116. The contract tool 104 can check the compliance periodically or upon request of the user 106 of the contract tool 104.

In 410, the contract tool can generate reports of upcoming actions, completed actions, and overdue actions. Based on whether the task is completed or pending, the contract tool 104 can generate one or more reports that indicates whether actions are upcoming, completed, and overdue. The reports can be generated automatically by the contract tool 104 or upon request of the user 106 of the contract tool 104.

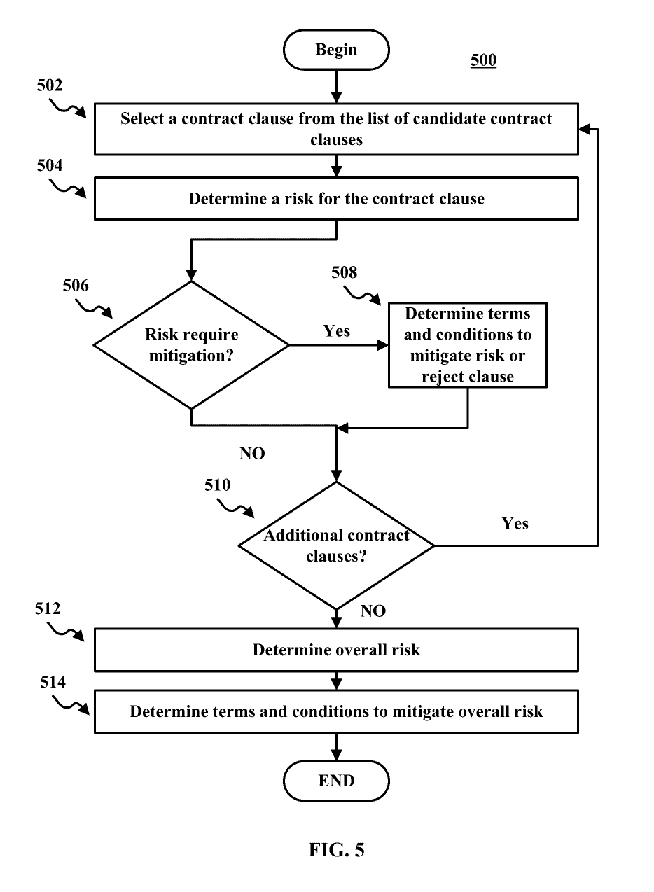

According to aspects, the contract tool 104 can be configured to assess the risk of the list of candidate contract clauses and suggest terms and conditions to mitigate the risk of the list of candidate contract clauses. FIG. 5 illustrates one example of a process 500 for assess the risk of the list of candidate contract clauses and suggest terms and conditions to mitigate the risk of the list of candidate contract clauses, according to aspects of the present disclosure. While FIG. 5 illustrates various stages that can be performed, stages can be removed and additional stages can be added. Likewise, the order of the illustrated stages can be performed in any order.

Once the process begins, in 502, the contract tool can select a contract clause from the list of candidate contract clauses. For example, the contract tool 104 can examine the list of candidate contract clauses and select one or the contract clauses from the list, for instance, the first contract clause in the list of candidate clauses.

For example, the list of candidate clauses can include a termination clause:

### 52.249-2 Termination for Convenience of the Government (Fixed-Price) (Apr. 2012)

(a) The Government may terminate performance of work under this contract in whole or, from time to time, in part if the Contracting Officer determines that a termination is in the Government's interest. The Contracting Officer shall terminate by delivering to the Contractor a office of Termination specifying the extent of termination and the effective date.

(b) After receipt of a Notice of Termination, and except as directed by the Contracting Officer, the Contractor shall immediately proceed with the following obligations, regardless of any delay in determining or adjusting any amounts due under this clause:

(1) Stop work as specified in the notice.

(2) Place no further subcontracts or orders (referred to as subcontracts in this clause) for materials, services, or facilities, except as necessary to complete the continued portion of the contract.

(3) Terminate all subcontracts to the extent they relate to the work terminated.

The contract tool 104 can select the “52.249-2” clause for risk assessment. 3

In 504, the contract tool can determine a risk for the contract clause. In aspects, the risk can represent a potential risk that contract clause posses. The contract tool 104 can maintain the risk record 118 that maps contract clauses to a base risk score. The contract tool 104 can search the risk record 118 for the contract clause and determine the base risk score for the contract clause.

In aspects, the base risk score can be a numerical value. For example, the base risk score can be a number between 0 and 100, where 0 represent no risk and 100 represents highly risky. Table 4 illustrates a matrix that maps ranges of risks score to potential risk.

TABLE 4

| Base Risk Score | Risk Level |
|---|---|
| 0-33 | Low Risk |
| 34-66 | Medium Risk |
| 67-100 | High Risk |

For instance in the above example, if the “52.249-2” clause is selected, the contract tool 104 can examine the risk record and determine that the clause “52.249-2” has a base score of “100,” demoting high risk.

In aspects, the contract tool 104 can also examine the contract clause and modify the base score based on the contract clause. For example, the contract tool 104 can parse the contract clause and search for words to denote risk. The terms can include, example, “terminate” “liable” “inspect” etc. that indicate that the base risk score should be increased. If a term exists, the contract tool 104 can increase the base score by a predetermined value that corresponds to the term in the contract clause. For example, if a contract clause includes a term “liable,” the contract tool 104 can determine to increase the base risk score by a predetermined value of “30.”

In aspects, the contract tool 104 can also receive a subject risk level from the user 106 of the contract tool 104. For example, the user 106 may desire to rate certain contract clauses as a higher risk. The contract tool 104 can be configured to allow the user 106 enter a specific risk value to be added to particular contract clauses.

In aspects, the contract tool 104 can determine the base risk score using any combination of the processes described. For example, the contract tool 104 can utilize the base risk score contained in the risk record. Likewise, for example, the contract tool 104 can utilize the base score from the risk record modify by the word search and/or subject risk entered by the user 106.

In aspects, the contract tool 104 can also weight the base risk score based on the particular sub-contract and/or PO. The weighting can reduce or increase the base risk score based on factors or details of the particular sub-contract. The factor or details can include value of the sub-contract and/or PO, performance history of the sub-contractor, importance of the sub-contract and/or PO, and the like. For instance in the above example, if the “52.249-2” clause is determined and given base score of “100”, the tool could can weight the risk score lower based on the particular sub-contract and/or PO or sub-contractor (e.g., low dollar value, good history of the sub-contractor, other mitigating terms in the contract, etc.”).

In 506, the contract tool can determine if the risk requires mitigation. In aspects, the contract tool 104 can maintain a matrix that detonates action to be taken based on the risk score. For example, Table 5 illustrates an example of a matrix used by the contract tool 104.

TABLE 5

| Risk Score | Action |
|---|---|
| 0-33 | Accept |
| 34-66 | Attempt to Mitigate |
| 67-100 | Reject |

In 508, if the risk is greater than the threshold, the contract tool can determine terms and conditions to mitigate risk or reject the contract clause. In aspects, the contract tool 104 can maintain a mitigation record of terms and condition to mitigate particular contract clauses.

For instance in the above example, if the “52.249-2” clause is selected, the contract tool 104 can examine the risk record and determine that the clause “52.249-2” has a base score of “100,” demoting high risk. The contract tool 104 can reject the clause based on the risk score of “100.”

In another example, if the “52.249-2” clause is selected, the contract tool 104 can examine the risk record and determine that the clause “52.249-2” has a base score of “100,” demoting high risk. Additionally, based on the factors of the sub-contract or PO, the contract tool 104 can weight the risk score for the “52.249-2” to be “50.” The contract tool 104 can determine a term or condition to mitigate the risk. For example, the contract tool 104 can search the mitigation record and determine that a condition exists to mitigate the risk:

### Termination for Convenience

a. Buyer may terminate all or part of this Contract for its sole convenience. In the event of such termination, Seller shall immediately stop all work hereunder and shall immediately cause any and all of its suppliers and subcontractors to stop work . . . .

In 510, if the risk is not greater than the threshold or after the terms and condition are determined or the clauses rejected, the contract tool can determine if additional contract clauses are available in the list of candidate clause to evaluate.

If additional contract clauses are available, the method 300 can return to 502. For example, the contract tool 104 can determine that the list of candidate contract clause also includes the contract clause:

### 52.246-2 Inspection of Supplies

This clause allows the customer to inspect hardware at suppliers. The contract tool 104 can determine that the clause “52.246-2” has a risk value of “45,” a moderate risk. The contract tool 104 can determine a term or condition to mitigate the risk, for example, a term that allow inspection.

If additional contract clauses are not available, the method can proceed to 512. In 512, the contract tool can determine the overall risk of the list of candidate clauses. In aspects, the contract tool 104 can combine the risk value for each contract clause to determine an overall risk for the list on candidate clauses. The contract tool 104 can be configured to utilize any type of statistical algorithm to combine the risk for each contract clause. For example, the contract tool 104 can determine, as the overall risk, a median or mean value for the risk values of the list of candidate contract clauses.

In aspects, the risk values of the list of candidate clauses, used in the overall risk score, can be modified based on the mitigation determine in 508. For example, if a contract clause is rejected, the contract tool 104 can remove the risk value of the contract clause. Likewise, for example, if a contract clause has a term or condition to mitigate the risk, the risk value for the contract clause can be modified to represent a lower risk. For instance, the term or condition to mitigate the risk can be assigned a value that reduces the risk value of the contract clause.

In 512, the contract tool can determine terms and conditions to mitigate overall risk. As in the process described above, the contract tool 104 can search the mitigation record and determine terms or conditions that mitigate the overall risk of the list of candidate contract clauses. For example, the contract tool 104 can search the mitigation record and determine that a condition exists (if not already included in the terms and conditions) to mitigate overall risk by allowing termination of the contract for any reason:

### Termination for Convenience

a. Buyer may terminate all or part of this Contract for its sole convenience. In the event of such termination, Seller shall immediately stop all work hereunder and shall immediately cause any and all of its suppliers and subcontractors to stop work . . . .

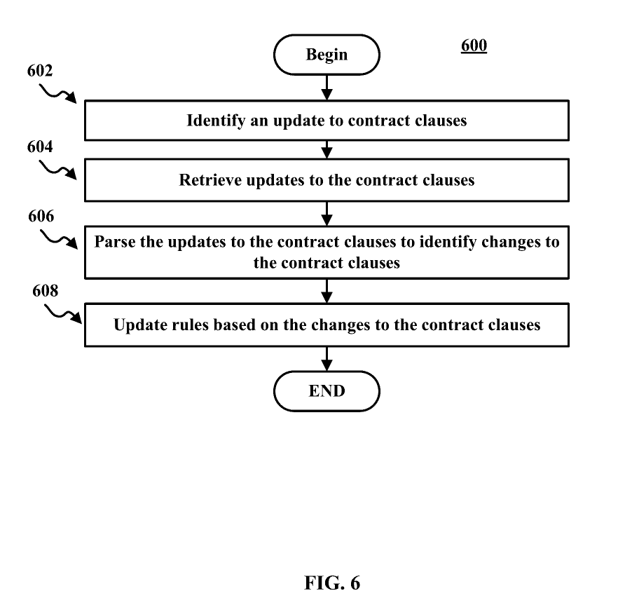

According to aspects, the contract tool 104 can be configured to regularly update the rules 110 as the contract clauses change over time. FIG. 6 illustrates one example of a process 600 for updating the contract tool, according to aspects of the present disclosure. While FIG. 6 illustrates various stages that can be performed, stages can be removed and additional stages can be added. Likewise, the order of the illustrated stages can be performed in any order.

Once the process begins, in 602, the contract tool can identify an update to contract clauses. For example, the contract tool 104 can communicate with the clause repository 114 to determine whether any updates have occurred to the contract clauses. In some aspects, the contract tool 104 can periodically communicate with the clause repository 114 to determine whether any updates have occurred. In some aspects, the contract tool 104 can communicate with the clause repository 114 in response to a notification that an update has occurred. In some aspects, the contract tool 104 can communicate with the clause repository 114 at the request of the user 106.

In 604, once an update is identified, the contract tool can retrieve updates to the contract clauses. For example, the contract tool 104 can retrieve, for the clause repository 114, any contract clauses that have been updated. In some aspects, for example, the contract tool 104 can retrieve all contract clauses to determine if an update has occurred.

In 606, the contract tool can parse the updates to the contract clauses to identify changes to the contract clauses. The contract tool 104 can maintain a dictionary of terms to search for in each parsed clause. The dictionary can include terms such as dollar signs ($), keywords, conditional phrases, explicit applicability sections in the clause, etc. For example, the contract tool 104 can parse the text of the contract clauses to determine if the contract clauses include any conditional language that may affect the rules 110. For instance, in some aspects, the contract tool 104 can parse the text of the contract clauses to identify any text that is associated with parameters of the sub-contract or PO, e.g., dollar values. Likewise, in some aspects, the contract tool 104 can parse the text of the contract clauses to identify any text that denotes conditional applicability of the contract clause, e.g., condition language such as “applies,” “if,” “only,” “expect,” etc.

In 608, the contract tool can update rules based on the changes to the contract clauses. For example, the contract tool 104 can compare the updates, determined during the parsing, to the rules 110. In some aspect, if the update differs from the one or more of the rules 110, the contract tool 104 can update the one or more rules 110. If the update is not included in the rules 110, the contract tool 104 can generate a new rule to be included in the rules 110.

For example, in the governmental contracting example, the contract tool 104 may determine that Clause 36 (Table 1) has changed text to read “this clause applies only if Seller delivers hazardous or dangerous material under this contract.” The contract tool 104 can parse the language of Clause 36 and identify conditional language. The contract tool 104 can compare the updated language to the previous language of the Clause 36 “this clause applies only if Seller delivers hazardous material under this contract.” Because the contract tool 104 identifies a change, the contract tool 104 can update Questions 7 (Table 3) to “Is the supplier delivering hazardous or dangerous material?”

The foregoing description is illustrative, and variations in configuration and implementation can occur to persons skilled in the art. For instance, the various illustrative logics, logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but, in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

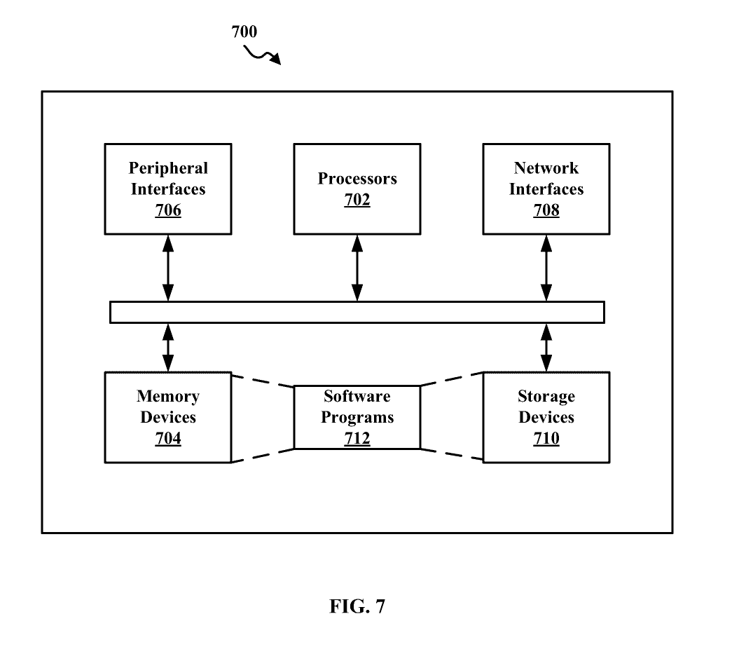

For example, FIG. 7 illustrates an example of a hardware configuration for the computer system 102. While FIG. 7 illustrates various components contained in the computer device 700, FIG. 7 illustrates one example of a computer device and additional components can be added and existing components can be removed.

The computer device 700 can be any type of computer device. As illustrated in FIG. 7, the computer device 700 can include one or more processors 702 of varying core configurations and clock frequencies. The computer device 700 can also include one or more memory devices 704 that serve as a main memory during the operation of the computer device 700. For example, during operation, a copy of the software that supports the contract tool 104 and the rules 110 can be stored in the one or more memory devices 704. The computer device 700 can also include one or more peripheral interfaces 706, such as keyboards, mice, touchpads, computer screens, touchscreens, etc., for enabling human interaction with and manipulation of the computer device 700.

The computer device 700 can also include one or more network interfaces 708 for communicating via one or more networks, for example the network 112, such as Ethernet adapters, wireless transceivers, or serial network components, for communicating over wired or wireless media using protocols. The computer device 700 can also include one or more storage device 710 of varying physical dimensions and storage capacities, such as flash drives, hard drives, random access memory, etc., for storing data, such as images, files, and program instructions for execution by the one or more processors 702.

Additionally, the computer device 700 can include one or more software programs 712 that enable the functionality of the contract tool 104 described above. The one or more software programs 712 can include instructions that cause the one or more processors 702 to perform the processes described herein. Copies of the one or more software programs 712 can be stored in the one or more memory devices 704 and/or on in the one or more storage devices 710. Likewise, the data, for example, the rules 110, utilized by one or more software programs 712 can be stored in the one or more memory devices 704 and/or on in the one or more storage devices 710.

The computer device 700 can include a variety of data stores and other memory and storage media as discussed above. These can reside in a variety of locations, such as on a storage medium local to (and/or resident in) one or more of the computers or remote from any or all of the computers across the network. In some implementations, information can reside in a storage-area network (“SAN”) familiar to those skilled in the art. Similarly, any necessary files for performing the functions attributed to the computers, servers, or other network devices may be stored locally and/or remotely, as appropriate.

In implementations, the components of the computer device 700 as described above need not be enclosed within a single enclosure or even located in close proximity to one another. Those skilled in the art will appreciate that the above-described componentry are examples only, as the computer device 700 can include any type of hardware componentry, including any necessary accompanying firmware or software, for performing the disclosed implementations. The computer device 700 can also be implemented in part or in whole by electronic circuit components or processors, such as application-specific integrated circuits (ASICs) or field-programmable gate arrays (FPGAs).

If implemented in software, the functions can be stored on or transmitted over a computer-readable medium as one or more instructions or code. Computer-readable media includes both tangible, non-transitory computer storage media and communication media including any medium that facilitates transfer of a computer program from one place to another. A storage media can be any available tangible, non-transitory media that can be accessed by a computer. By way of example, and not limitation, such tangible, non-transitory computer-readable media can comprise RAM, ROM, flash memory, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, DVD, floppy disk and Blu-ray disc where disks usually reproduce data magnetically, while discs reproduce data optically with lasers. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above should also be included within the scope of computer-readable media.

While the teachings have been described with reference to examples of the implementations thereof, those skilled in the art will be able to make various modifications to the described implementations without departing from the true spirit and scope. The terms and descriptions used herein are set forth by way of illustration only and are not meant as limitations. In particular, although the processes have been described by examples, the stages of the processes can be performed in a different order than illustrated or simultaneously. Furthermore, to the extent that the terms “including”, “includes”, “having”, “has”, “with”, or variants thereof are used in the detailed description, such terms are intended to be inclusive in a manner similar to the term “comprising.” As used herein, the terms “one or more of” and “at least one of” with respect to a listing of items such as, for example, A and B, means A alone, B alone, or A and B. Further, unless specified otherwise, the term “set” should be interpreted as “one or more.” Also, the term “couple” or “couples” is intended to mean either an indirect or direct connection. Thus, if a first device couples to a second device, that connection can be through a direct connection, or through an indirect connection via other devices, components, and connections.

TABLE 1

| Clause number | Clauses | Condition |
|---|---|---|
| Clause1 | 52.203-6 Restrictions on Subcontractor Sales to the | $100K |
| | Government (SEPTEMBER 2006). This clause applies only if this | |
| | contract exceeds $100,000. | |
| Clause2 | 52.203-7 Anti-Kickback Procedures (JULY 1995). Buyer | $100K |
| | may withhold from sums owed Seller the amount of any | |
| | kickback paid by Seller or its subcontractors at any tier if | |
| | (a) the Contracting Officer so directs, or (b) the | |
| | Contracting Officer has offset the amount of such | |
| | kickback against money owed Buyer under the prime | |
| | contract. This clause applies only if this contract exceeds | |
| | $100,000. | |
| Clause3 | 52.203-8 Cancellation, Rescission, and Recovery of | |
| | Funds for Illegal or Improper Activity (JANUARY 1997). | |
| Clause4 | 52.203-10 Price or Fee Adjustment for Illegal or | $100K |
| | Improper Activity (JANUARY 1997). This clause applies only | |
| | if this contract exceeds $100,000. If the Government | |
| | reduces Buyer's price or fee for violations of the Act by | |
| | Seller or its subcontractors at any tier, Buyer may | |
| | withhold from sums owed Seller the amount of the | |
| | reduction. | |
| Clause5 | 52.203-11, Certification and Disclosure Regarding | $10K |
| | Payments to Influence Certain Federal Transactions. This | |
| | Certification states that the prospective subcontractor has | |
| | not engaged in any of the prohibited activities set forth in | |
| | these clauses except for those disclosed on OMB | |
| | Standard Form LLL, Disclosure of Lobbying Activities. | |
| Clause6 | 52.203-12 Limitation on Payments to Influence Certain | $100K |
| | Federal Transactions (SEPTEMBER 2007). This clause applies | |
| | only if this contract exceeds $100,000. Paragraph (g)(2) | |
| | is modified to read as follows: “(g)(2) Seller will | |
| | promptly submit any disclosure required (with written | |
| | notice to Insitu) directly to the PCO for the prime | |
| | contract. Insitu will identify the cognizant Government | |
| | PCO at Seller's request. Each subcontractor certification | |
| | will be retained in the subcontract file of the awarding | |
| | contractor.” | |
| Clause7 | 52.203-13 Contractor Code of Business Ethics and | Does this subcontract |
| | Conduct (DECEMBER 2008). This clause applies only if this | have a period of |
| | contract is in excess of $5,000,000, has a period of | performance of more |
| | performance of more than 120 days, and is not for a | than 120 days or is |
| | commercial item or performed entirely outside the | performed entirely |
| | United States. For the purposes of this clause, the United | outside the United |
| | States is defined as the 50 states, the District of | States? |
| | Columbia, and outlying areas. | |
| Clause8 | 52.203-14 Display of Hotline Poster(s) (DECEMBER 2007). | Same as 7 |
| Clause9 | 52.204-2 Security Requirements (AUGUST 1996). Changes | Does the supplier |
| | clause means the changes clause of this contract. This | have access to |
| | clause applies only if access to classified material is | classified material in |
| | required. | regards to this |
| | | contract? |
| Clause10 | 52.204-9 Personal Identity Verification of Contractor | Does the |
| | Personnel. (SEPTEMBER 2007). This clause applies only if | performance under |
| | performance under this contract requires Seller to have | this contract require |
| | routine physical access to a Federally controlled facility | the supplier to have |
| | and/or routine access to a Federally-controlled | routine physical |
| | information system. | access to federally |
| | | controlled facility |
| | | and/or routine access |
| | | to federally |
| | | controlled |
| | | information system? |
| Clause11 | 52.209-6, Protecting the Government's Interest When | Always |
| | Subcontracting With Contractors Debarred, Suspended, | |
| | or Proposed for Debarment. The clause prohibits the | |
| | company from issuing purchase orders of $30,000 or | |
| | more to subcontractors who are debarred, suspended, or | |
| | proposed for debarment without giving notice, as set | |
| | forth in FAR 52.209-6, signed by a corporate officer or | |
| | designee, to the Government Contracting Officer. | |
| | Procurement agents shall comply with their local site | |
| | requirements regarding the certification required by this | |
| | FAR clause. Contact the Procurement/Subcontract | |
| | Advisor for further guidance if a supplier fails or refuses | |
| | to execute the designated certification. Refer to PUG-74- | |
| | 001 May. 3, 2006 for further information and guidance. | |
| Clause12 | 52.211-5 Material Requirements (AUGUST 2000). | Is this procurement |
| | | for hardware? |
| Clause13 | 52.211-15 Defense Priority And Allocation | Flow down always |
| | Requirements (April 2008) | |
| Clause14 | 52.215-2 Audit and Records - Negotiation (MARCH 2009). | $100K |
| | This clause applies only if this contract exceeds $100,000 | |
| | and (i) is cost-reimbursement, incentive, time-and- | |
| | materials, labor-hour, or price-redeterminable type or any | |
| | combination of these types: (ii) Seller was required to | |
| | provide cost or pricing data, or (iii) Seller is required to | |
| | furnish reports as discussed in paragraph (e) of the | |
| | referenced clause. | |
| Clause15 | 52.215-10 Cost or Pricing Data (OCTOBER 1997). This clause | $700K |
| | applies only if this contract exceeds the threshold set | |
| | forth in FAR 15.403-4 and is not otherwise exempt. In | |
| | subparagraph (3) of paragraph (a), insert “of this | |
| | contract” after “price or cost.” In Paragraph (c), | |
| | “Contracting Officer” shall mean “Contracting Officer or | |
| | Buyer.” In Paragraphs (c)(1), (c)(1)(ii), and (c)(2)(i), | |
| | “Contracting Officer” shall mean “Contracting Officer or | |
| | Buyer.” In Subparagraph (c)(2)(i)(A), delete “to the | |
| | Contracting Officer.” In Subparagraph (c)(2)(ii)(B), | |
| | “Government” shall mean “Government or Buyer.” In | |
| | Paragraph (d), “United States” shall mean “United States | |
| | or Buyer.” | |
| Clause16 | 52.215-11 Cost or Pricing Data--Modifications October 1997 | $700K |
| Clause17 | 52.215-12 Subcontractor Cost or Pricing Data (OCTOBER | $700K |
| | 1997). This clause applies only if this contract exceeds | |
| | the threshold set forth in FAR 15.403-2 (currently | |
| | $700,000), and is not otherwise exempt. The certificate | |
| | required by paragraph (b) of the referenced clause shall | |
| | be modified as follows: delete “to the Contracting Officer | |
| | or the Contracting Officer's representative” and substitute | |
| | in lieu thereof “to Insitu, Inc. or Insitu's representative | |
| | (including data submitted, when applicable, to an | |
| | authorized representative of the U.S. Government).” | |
| Clause18 | 52.215-13 Subcontractor Cost or Pricing Data-- | $700K |
| | Modifications October 1997 | |
| Clause19 | 52.215-14 Integrity of Unit Prices (OCTOBER 1997). This | $100K + Q: Is your |
| | clause applies except for contracts at or below $100,000; | procurement for |
| | construction or architect-engineer services under FAR | construction or |
| | Part 36; utility services under FAR Part 41; services | architect-engineer |
| | where supplies are not required; commercial items; and | services under FAR |
| | petroleum products. | Part 36; utility |
| | | services under FAR |
| | | Part 41; services |
| | | where supplies are |
| | | not required; |
| | | commercial items; |
| | | and petroleum |
| | | products. −Yes |
| | | doesn't apply, under |
| | | 100K delete Yes and |
| | | No |
| Clause20 | 52.215-15 Pension Adjustments and Asset Reversions | $700K |
| | (OCTOBER 2004). This Clause applies to this contract if it | |
| | meets the requirements of FAR 15.408(g). | |
| Clause21 | 52.215-18 Reversion or Adjustment of Plans for Post- | $700K |
| | Retirement Benefits (PRB) Other Than Pensions (JULY | |
| | 2005). This Clause applies to this contract if it meets the | |
| | requirements of FAR 15.408(j). | |
| Clause22 | 52.215-19 Notification of Ownership Changes (OCTOBER | $700K |
| | 1997). This Clause applies to this contract if it meets the | |
| | requirements of FAR 15.408(k). | |
| Clause23 | 52.215-21 Requirement for Cost or Pricing Data or | $700K |
| | Information Other Than Cost and Pricing Data - | |
| | Modifications (OCTOBER 1997). This clause applies only if | |
| | this contract exceeds the threshold set forth in FAR | |
| Clause24 | 15.403-4. The term “Contracting Officer” shall mean | NA |
| | Buyer. | |
| Clause25 | 52.219-8 Utilization of Small Business Concerns (MAY | $150K |
| | 2004). | |
| Clause26 | 52.219-9 Small-Business Subcontracting Plan (APRIL | $650K + Q: Is the |
| | 2008). | supplier a small |
| | This clause applies only if this contract exceeds $650,000 | business? +Buyer |
| | and Seller is not a small business concern. | Action submit SB |
| | Seller shall adopt a subcontracting plan that complies | Plan |
| | with the requirements of this clause. In addition, Seller | |
| | shall submit to Buyer, Small and Small Disadvantaged | |
| | Business and Women-Owned Small Business | |
| | Subcontracting Plan Certificate of Compliance. In | |
| | accordance with paragraph (d)(10)(iv), Seller agrees that | |
| | it will submit the ISR and/or SSR using eSRS, and, in | |
| | accordance with paragraph (d)(10)(vi), Seller agrees to | |
| | provide the prime contract number, its own DUNS | |
| | number, and the email address of the Government or | |
| | Contractor official responsible for acknowledging or | |
| | rejecting the reports, to its subcontractors with | |
| | subcontracting plans. | |
| Clause27 | 52.222-4 Contract Work Hours and Safety Standards Act- | $100K |
| | Overtime Compensation (July 2005) | |
| Clause28 | 52.222-20 Walsh-Healey Public Contracts Act (DECEMBER | $10K |
| | 1996). This clause applies only if this contract exceeds | |
| | $10,000. | |
| Clause29 | 52.222-21 Prohibition of Segregated Facilities (FEBRUARY | $10K |
| | 1999). | |
| Clause30 | 52.222-26 Equal Opportunity (MARCH 2007). | $10K |
| Clause31 | 52.222-35 Equal Opportunity for Special Disabled | $100K |
| | Veterans, Veterans of the Vietnam Era, and Other | |
| | Eligible Veterans (SEPTEMBER 2006). This clause applies only if | |
| | this contract exceeds $100,000. | |
| Clause32 | 52.222-36 Affirmative Action For Workers With | $15K |
| | Disabilities (JUNE 1998). This clause applies only if this | |
| | contract exceeds $15,000. | |
| Clause33 | 52.222-37 Employment Reports on Special Disabled | $100K |
| | Veterans, Veterans of the Vietnam Era, and Other | |
| | Eligible Veterans (SEPTEMBER 2006). This clause applies only if | |
| | this contract exceeds $100,000. | |
| Clause34 | 52.222-39 Notification of Employee Rights Concerning | $netK |
| | Payment of Union Dues or Fees (DECEMBER 2004). | |
| Clause35 | 52.222-50 Combating Trafficking in Persons (FEBRUARY | Always |
| | 2009). | |
| Clause36 | 52.223-3 Hazardous Material Identification and Material | Is the supplier |
| | Safety Data (JANUARY 1997). This clause applies only if | delivering hazardous |
| | Seller delivers hazardous material under this contract. | material? |
| Clause37 | 52.223-11, Ozone Depleting Substance. This provision | Is this subcontract |
| | defines Class I and II ozone-depleting substances | for the purchase of |
| | | “Ozone-depleting |
| | | substances” as |
| | | defined in FAR |
| | | 52.223-11? |
| Clause38 | 52.223-14 Toxic Chemical Release Reporting (AUGUST | Is your procurement |
| | 2003). This clause applies only if this contract is not for | not for commercial |
| | commercial items as defined in FAR Part 2, was | items as defined in |
| | competitively awarded, and exceeds $100,000 (including | FAR Part 2, was |
| | all options). | competitively |
| | | awarded, and |
| | | exceeds $100,000 |
| | | (including all |
| | | options)? |
| Clause39 | 52.225-13 Restriction on Certain Foreign Purchases | |
| | (JUNE 2008). | |
| Clause40 | 52.227-1 Authorization and Consent (DECEMBER 2007) Alt 1 | $150K |
| | (APRIL 1984). | |
| Clause41 | 52.227-2 Notice and Assistance Regarding Patent and | $150K |
| | Copyright Infringement (DECEMBER 2007). A copy of each | |
| | notice sent to the Government will be sent to Buyer. | |
| Clause42 | 52.227-10 Filing of Patent Applications - Classified | Clause 14 |
| | Subject Matter (DECEMBER 2007). | |
| Clause43 | 52.227-11 Patent Rights--Ownership By The Contractor | Always |
| | December 2007 | |
| Clause44 | 52.228-3 WORKERS' COMPENSATION INSURANCE | Defense based Act |
| | (DEFENSE BASE ACT) (APRIL 1984) | |
| Clause45 | 52.228-4 WORKERS' COMPENSATION AND WAR- | |
| | HAZARD INSURANCE OVERSEAS (APRIL 1984) | |
| Clause46 | 52.228-7 Insurance--Liability To Third Persons March 1996 | |
| Clause47 | 52.230-2 Cost Accounting Standards October 2008 | $500K |
| Clause48 | 52.230-3 Disclosure And Consistency Of Cost | $500K |
| | Accounting Practices October 2008 | |
| Clause49 | 52.230-6 Administration of Cost Accounting Standards | $500K |
| | (MARCH 2008). Add “Buyer and the” before | |
| | CFAO in paragraph (m). This provision applies if clause | |
| | H001, H002, or H004 is included in this contract. | |
| | H001: The clause entitled “Cost Accounting Standards,” | |
| | FAR 52.230-2, excluding paragraph (b), is incorporated | |
| | herein by reference. In this clause, “Contractor” shall | |
| | mean Seller, and any reference to “disputes” or the | |
| | “Contract Disputes Act” shall mean the Disputes clause | |
| | of this contract. The version of FAR 52.230-2 | |
| | incorporated in this contract is stated in the Cost | |
| | Accounting Standards article of the Customer Contract | |
| | Requirements (CCR) incorporated in this contract. | |
| | H002: DISCLOSURE AND CONSISTENCY IN COST | |
| | ACCOUNTING PRACTICES | |
| | The clause entitled “Disclosure and Consistency in Cost | |
| | Accounting Practices,” FAR 52.230-3, excluding | |
| | paragraph (b), is incorporated herein by reference. In this | |
| | clause, “Contractor” shall mean Seller, and any reference | |
| | to “disputes” or the “Contract Disputes Act” shall mean | |
| | the Disputes clause of this contract. The version of FAR | |
| | 52.230-3 incorporated in this contract is stated in the | |
| | Cost Accounting Standards article of the Customer | |
| | Contract Requirements (CCR) incorporated in this | |
| | contract. | |
| | H004: COST ACCOUNTING STANDARDS - | |
| | EDUCATIONAL INSTITUTION | |
| | The clause entitled “Cost Accounting Standards - | |
| | Educational Institution,” FAR 52.230-5, | |
| | excluding paragraph (b), is incorporated herein by | |
| | reference. In this clause, “Contractor” shall mean Seller, | |
| | and any reference to “disputes” or the “Contract Disputes | |
| | Act” shall mean the Disputes clause of this contract. The | |
| | version of FAR 52.230-5 incorporated in this contract is | |
| | stated in the Cost Accounting Standards article of the | |
| | Customer Contract Requirements (CCR) incorporated in | |
| | this contract. | |
| Clause50 | 52.232-16, Progress Payments. | Always |
| Clause51 | 52.234-1 INDUSTRIAL RESOURCES DEVELOPED | |
| | UNDER DEFENSE PRODUCTION ACT TITLE III | |
| | (DECEMBER 1994) (a) Definitions. “Title III industrial | |
| | resource” means materials, services, processes, or | |
| | manufacturing equipment (including the processes, | |
| | technologies, and ancillary services for the use of such | |
| | equipment) established or maintained under the authority | |
| | of Title III, Defense Production Act (50 U.S.C. App. | |
| | 2091-2093). “Title III project contractor” means a | |
| | contractor that has received assistance for the | |
| | development or manufacture of an industrial resource | |
| | under 50 U.S.C. App. 2091-2093, Defense | |
| | Production Act. (b) The Contractor shall refer any | |
| | request from a Title III project contractor for testing and | |
| | qualification of a Title III industrial resource to the | |
| | Contracting Officer. (c) Upon the direction of the | |
| | Contracting Officer, the Contractor shall test Title III | |
| | industrial resources for qualification. The Contractor | |
| | shall provide the test results to the Defense Production | |
| | Act Office, Title III Program, located at Wright Patterson | |
| | Air Force Base, Ohio 45433-7739. (d) When the | |
| | Contracting Officer modifies the contract to direct testing | |
| | pursuant to this clause, the Government will provide the | |
| | Title III industrial resource to be tested and will make an | |
| | equitable adjustment in the contract for the costs of | |
| | testing and qualification of the Title III industrial resource. | |
| | (e) The Contractor agrees to insert the substance of this | |
| | clause, including paragraph (e), in every subcontract | |
| | issued in performance of this contract. | |
| Clause52 | 52.242-15 Stop-Work Order (AUGUST 1989). Change “90 | Always |
| | days” and “30 days” to “100 days” and “20 days” | |
| | respectively. The terms “Contracting Officer” and | |
| | “Government” shall mean Buyer. | |
| Clause53 | 52.244-2, Subcontracts (JUNE 2007) There are advance | Does this |
| | notification or consent requirements for any | procurement require |
| | subcontractors not listed in paragraph (j) therein. Namely | AcO notification or |
| | all subcontractors other than Harris, Boeing and Corsair | consent? (If the |
| | who were listed as “evaluated during negotiation” by the | supplier is Harris, |
| | Govt. | Boeing, or Corsair, |
| | | click NO) |
| Clause54 | 52.244-6 Subcontracts for Commercial Items (DECEMBER | Always |
| | 2009) | |
| Clause55 | 52.245-1 Government Property June 2007 | Always |
| Clause56 | 52.247-63 Preference For U.S. Flag Air Carriers (June 2003) | Does this |
| | | procurement involve |
| | | international air |
| | | transportation. |
| Clause57 | 52.247-64 Preference for Privately Owned U.S. - Flag | Does this |
| | Commercial Vessels (February 2006) | procurement involve |
| | | transportation of |
| | | equipment, materials |
| | | or commodities in |
| | | ocean vessels? |
| Clause58 | 252.203-7001 Prohibition on Persons Convicted of | $100K |
| | Fraud or Other Defense-Contract-Related Felonies | |
| | (DECEMBER 2008). This clause applies only if this contract | |
| | exceeds $100,000 and does not apply to the purchase of | |
| | commercial items or commercial components. | |
| | “Contractor” and “contract” are not changed in | |
| | paragraphs (a) and (b). In paragraph (e), “Government” | |
| | shall mean Government or Buyer. In paragraph (f), | |
| | “through the Buyer” is inserted after “Contracting | |
| | Officer”. Paragraph (g) is deleted and “Contracting | |
| | Officer” shall mean Contracting Officer. | |
| Clause59 | 252.204-7000 Disclosure of Information (DECEMBER 1991). | Always |
| Clause60 | 252.211-7000 Acquisition Streamlining December 1991 required | $1.5 Million |
| | for contracts over $1.5 million. | |
| Clause61 | 252.211-7003 Item Identification and Valuation (AUGUST | Always |
| | 2008). Seller shall comply with the unique item | |
| | identification requirements of this clause for those | |
| | subassemblies, components, and parts specified | |
| | elsewhere in this contract. Such identification and | |
| | marking shall be a high-capacity 2D machine readable | |
| | code to comply with the version of MIL-STD-130, | |
| | Identification Marking of U.S. Military Property, set | |
| | forth elsewhere in this contract; or if not so stated, then | |
| | the Seller shall comply with M IL-STD-130 N. The code | |
| | may include, as space is available, linear bar code and | |
| | human readable characters. Unless otherwise specified in | |
| | Insitu product drawings or specifications, the seller may | |
| | use either Construct #1 or Construct #2. The Seller shall | |
| | not be required to furnish item valuations as set forth in | |
| | this clause. | |
| Clause62 | 252.215-7000 Pricing Adjustments (DECEMBER 1991). This | $650K |
| | clause applies only if this contract exceeds $650,000. | |
| Clause63 | 252.215-7003, Excessive Pass-Through Charges (May 2008) | |
| Clause64 | 252.215-7004 Excessive Pass-Through Charges (MAY 2008). | |
| | This clause applies unless this contract is (1) a firm- | |
| | fixed-price contract awarded on the basis of adequate | |
| | price competition; (2) a fixed-price contract with | |
| | economic price adjustment awarded on the basis of | |
| | adequate price competition; (3) a firm-fixed-price | |
| | contract for the acquisition of a commercial item, or (4) a | |
| | fixed-price contract with economic price adjustment for | |
| | the acquisition of a commercial item. In paragraph (a), | |
| | “Contractor” retains its original meaning. In paragraph | |
| | (b), “Government” and “Contracting Officer” mean | |
| | Buyer. In paragraph (c) “Contracting Officer” means | |
| | Buyer. In paragraph (d), “Government” and “Contracting | |
| | Officer” mean Buyer. In paragraph (e), “Contracting | |
| | Officer” retains its original meaning. | |
| Clause65 | 252.219-7003 Small Business Subcontracting Plan (DOD | Depends on Clause |
| | Contracts) (APRIL 2007). Except paragraph (g) which is | 26 |
| | hereby deleted. | |
| Clause66 | 252.222-7006 Restrictions of the Use of Mandatory | Always |
| | Arbitration Agreements (May 2010) | |
| Clause67 | 252.225-7002 Qualifying Country Sources as | Always |
| | Subcontractors (APRIL 2003) | |
| Clause68 | 252.225-7004 Reporting Of Contract Performance | $550K |
| | Outside The United States And Canada - | |
| | Submission After Award (MAY 2007). The term | |
| | “Contractor” in paragraph (b) and the term “Contracting | |
| | Officer” in paragraphs (c) and (d) means “Buyer.” This | |
| | clause applies only if this contract exceeds $550,000. | |
| Clause69 | 252.225-7006 QUARTERLY REPORTING OF | Is your procurement |
| | ACTUAL CONTRACT PERFORMANCE OUTSIDE | greater 550K and not |
| | THE UNITED STATES (MAY 2007). This clause | for commercial |
| | applies only if this contract exceeds $550,000 and is not | items, construction, |
| | for commercial items, construction, ores, natural gases, | ores, natural gases, |
| | utilities, petroleum products and crudes, timber (logs), or | utilities, petroleum |
| | subsistence. | products and crudes, |
| | | timber (logs), or |
| | | subsistence. |
| Clause70 | 252.225-7009 Restriction on Acquisition of Certain | Does the item being |
| | Articles Containing Specialty Metals (JULY 2009) (10 | procured contain |
| | USC 2533b) | specialty metals? |
| | | Steel- |
| | | (A) With a maximum |
| | | alloy content |
| | | exceeding one or |
| | | more of the |
| | | following limits: |
| | | manganese, 1.65 |
| | | percent; silicon, 0.60 |
| | | percent; or copper, |
| | | 0.60 percent; or |
| | | (B) Containing more |
| | | than 0.25 percent of |
| | | any of the following |
| | | elements: |
| | | aluminum, |
| | | chromium, cobalt, |
| | | columbium, |
| | | molybdenum, nickel, |
| | | titanium, |
| | | tungsten, or |
| | | vanadium; |
| | | (ii) Metal alloys |
| | | consisting of nickel, |
| | | iron-nickel, and |
| | | cobalt base alloys |
| | | containing a |
| | | total of other |
| | | alloying metals |
| | | (except iron) in |
| | | excess of 10 percent; |
| | | (iii) Titanium and |
| | | titanium alloys; or |
| | | (iv) Zirconium and |
| | | zirconium base |
| | | alloys.” |
| Clause71 | 252.225-7013 Duty Free Entry (DECEMBER 2009). This clause | Always |
| | applies if Seller is located in a qualifying country (as | |
| | defined in DFARS Part 225.8) or if Seller is located in | |
| | any other country and the estimated U.S. duty for the | |
| | deliverable items will exceed $200 per unit. Seller shall | |
| | include the prime contract number on all shipping | |
| | documents submitted to Customs for supplies for which | |
| | duty-free entry is claimed pursuant to this clause. See | |
| | Section 5 for the information required by paragraph (j)(3) | |
| | of this clause. | |
| Clause72 | 252.225.7014 Preference for Domestic Specialty Metals | Same as 71 |
| | JUNE 2005) | |
| Clause73 | 252.225-7016 Restriction on Acquisition of Ball and | Does this contract |
| | Roller Bearings (MARCH 2006). | include the purchase |
| | | of ball or roller |
| | | bearings? |
| Clause74 | 252.225-7040 CONTRACTOR PERSONNEL | Is the subcontractors |
| | AUTHORIZED TO ACCOMPANY U.S. ARMED | personnel authorized |
| | FORCES DEPLOYED OUTSIDE THE UNITED | to accompany US |
| | STATES (JULY 2009) | Armed Forces |
| | The Contractor shall incorporate the substance of this | deployed outside the |
| | clause including paragraph (q), in all subcontracts when | US in (1) |
| | subcontractor personnel are authorized to accompany US | Contingency |
| | Armed Forces deployed outside the US in (1) | operations; (2) |
| | Contingency operations; (2) Humanitarian or | Humanitarian or |
| | peacekeeping operations; (3) Other military operations; | peacekeeping |
| | or (4) Military exercises designated by the Combatant | operations; (3) Other |
| | Commander. | military operations; |
| | | or (4) Military |
| | | exercises designated |
| | | by the Combatant |
| | | Commander? |
| Clause75 | 252.225-7043 Antiterrorism/Force Protection Policy for | Does this |
| | Defense Contractors Outside the United States March 2006 | procurement require |
| | | performance or travel |
| | | outside the United |
| | | States, except for |
| | | contracts with- (a) |
| | | Foreign |
| | | governments; (b) |
| | | Representatives of |
| | | foreign governments; |
| | | or (c) Foreign |
| | | corporations wholly |
| | | owned by foreign |
| | | governments. Not |
| | | Statutory. |
| | | Prescribed in |
| | | DFARS 225.7403-2 |
| Clause76 | 252.225-7997 Additional Requirements and | Q18 |
| | Responsibilities Relating to Alleged Crimes By Or | |
| | Against Contractor Personnel In Iraq and Afghanistan | |
| | (Deviation2010-O0014 (AUGUST 2010) | |
| Clause77 | 252.226-7001 Utilization of Indian Organizations and | $500K |
| | Indian-Owned Economic Enterprises, and Native | |
| | Hawaiian Small Business Concerns September 2004 required for | |
| | contracts over $500,000 | |
| Clause78 | 252.227-7013 Rights In Technical Data -- | Always |
| | Noncommercial Items (NOVEMBER 1995). This clause applies | |
| | only if the delivery of data is required for noncommercial | |
| | items under this contract. | |
| | (k) Applicability to subcontractors or suppliers. | |
| | (2) Whenever any technical data for noncommercial | |
| | items is to be obtained from a subcontractor or supplier | |
| | for delivery to the Government under this contract, the | |
| | Contractor shall use this same clause in the subcontract | |
| | or other contractual instrument, and require its | |
| | subcontractors or suppliers to do so, without alteration, | |
| | except to identify the parties. No other clause shall be | |
| | used to enlarge or diminish the Government's, the | |
| | Contractor's, or a higher-tier subcontractor's or supplier's | |
| | rights in a subcontractor's or supplier's technical data. | |
| Clause79 | 252.227-7014 RIGHTS IN NONCOMMERCIAL | Always |
| | COMPUTER SOFTWARE AND NONCOMMERCIAL | |
| | COMPUTER SOFTWARE DOCUMENTATION (JUNE | |
| | 1995) | |
| Clause81 | 252.227-7015 Technical Data--Commercial Items November 1995 | Always |
| Clause82 | 252.227-7016 Rights in Bid or Proposal Information June 1995 | Always |
| | Does not apply to commercial items or commercial | |
| | computer software or related documentation. | |
| Clause83 | 252.227-7019 Validation of Asserted Restrictions-- | Always |
| | Computer Software June 1995 | |
| | Does not apply to commercial items or commercial | |
| | computer software or related documentation. | |
| Clause84 | 252.227-7025 Limitations on the Use or Disclosure of | Always |
| | Government-Furnished Information Marked with | |
| | Restrictive Legends June 1995 | |
| Clause85 | 252.227-7026 Deferred Delivery Of Technical Data Or | Always |
| | Computer Software April 1988 | |
| Clause86 | 252.227-7027 Deferred Ordering Of Technical Data Or | Always |
| | Computer Software April 1988 | |
| Clause87 | 252.227-7030 TECHNICAL DATA--WITHHOLDING | Always |
| | OF PAYMENT (MARCH 2000) | |
| Clause88 | 252.227-7037 Validation of Restrictive Markings on | Same question as |
| | Technical Data September 1999 | clause 54 (if no, it |
| | | applies) see clause |
| | | 54 |
| Clause89 | 252.227-7038 Patent Rights--Ownership by the | Is this procurement |
| | Contractor (Large Business) December 2007 | for experimental, |
| | | developmental, or |
| | | research work? |
| Clause90 | 252.227-7039 Patents - Reporting of Subject Inventions | Not applicable |
| | (April 1990). Flowdown Not mandatory. Not Applicable | EVER |
| | to Large Business | |
| Clause91 | 252.228-7001 Ground and Flight Risk. | |
| | As prescribed in 228.370(b), use the following clause: | |
| | GROUND AND FLIGHT RISK (JUNE 2010) | |
| | (a) Definitions. As used in this clause- | |
| | (1) “Aircraft,” unless otherwise provided in the contract | |
| | Schedule, means- | |
| | (i) Aircraft to be delivered to the Government under this | |
| | contract (either before or after Government acceptance), | |
| | including complete aircraft and aircraft in the process of | |
| | being manufactured, disassembled, or reassembled; | |
| | provided that an engine, portion of a wing or a wing is | |
| | attached to a fuselage of the aircraft; | |
| | (ii) Aircraft, whether in a state of disassembly or | |
| | reassembly, furnished by the Government to the | |
| | Contractor under this contract, including all Government | |
| | property installed, in the process of installation, or | |
| | temporarily removed; provided that the aircraft and | |
| | property are not covered by a separate bailment | |
| | agreement; | |
| | (iii) Aircraft furnished by the Contractor under this | |
| | contract (either before or after Government acceptance); | |
| | or | |
| | (iv) Conventional winged aircraft, as well as helicopters, | |
| | vertical take-off or landing aircraft, lighter-than-air | |
| | airships, aerial vehicles, or other non-conventional | |
| | aircraft specified in this contract. | |
| | (2) “Contractor's managerial personnel” means the | |
| | Contractor's directors, officers, managers, | |
| | superintendents, or equivalent representatives who have | |
| | supervision or direction of- (i) All, or substantially all, | |
| | of the Contractor's business; (ii) All, or substantially all, | |
| | of the Contractor's operation at any one plant or separate | |
| | location; or (iii) A separate and complete major industrial | |
| | operation. | |
| | (3) “Contractor's premises” means those premises, | |
| | including subcontractors' premises, designated in the | |
| | Schedule or in writing by the Contracting Officer, and | |
| | any other place the aircraft is moved for safeguarding. | |
| | (4) “Flight” means any flight demonstration, flight test, | |
| | taxi test, or other flight made in the performance of this | |
| | contract, or for the purpose of safeguarding the aircraft, | |
| | or previously approved in writing by the Contracting | |
| | Officer, | |
| | (i) For land based aircraft, “flight” begins with the taxi | |
| | roll from a flight line on the Contractor's premises and | |
| | continues until the aircraft has completed the taxi roll in | |
| | returning to a flight line on the Contractor's premises, | |
| | (ii) For seaplanes, “flight” begins with the launching | |
| | from a ramp on the Contractor's premises and continues | |
| | until the aircraft has completed its landing run and is | |
| | beached at a ramp on the Contractor's premises, | |
| | (iii) For helicopters, “flight” begins upon engagement of | |
| | the rotors for the purpose of take-off from the | |
| | Contractor's premises and continues until the aircraft has | |
| | returned to the ground on the Contractor's premises and | |
| | the rotors are disengaged, | |
| | (iv) For vertical take-off or landing aircraft, “flight” | |
| | begins upon disengagement from any launching platform | |
| | or device on the Contractor's premises and continues | |
| | until the aircraft has been engaged to any launching | |
| | platform or device on the Contractor's premises. | |
| | (v) All aircraft off the Contractor's premises shall be | |
| | considered to be in flight when on the ground or water | |
| | for reasonable periods of time following emergency | |
| | landings, landings made in performance of this contract, | |
| | or landings approved in writing by the Contracting | |
| | Officer. | |
| | (5) “Flight crew member” means the pilot, the co-pilot, | |
| | and, unless otherwise provided in the Schedule, the flight | |
| | engineer, navigator, and bombardier-navigator when | |
| | assigned to their respective crew positions for the | |
| | purpose of conducting any flight on behalf of the | |
| | Contractor. It also includes any pilot or operator of an | |
| | unmanned aerial vehicle. If required, a defense systems | |
| | operator may also be assigned as a flight crew member. | |
| | (6) “In the open” means located wholly outside of | |
| | buildings on the Contractor's premises or other places | |
| | described in the Schedule as being “in the open.” | |
| | Government furnished aircraft shall be considered to be | |
| | located “in the open” at all times while in the | |
| | Contractor's possession, care, custody, or control. | |
| | (7) “Operation” means operations and tests of the aircraft | |
| | and its installed equipment, accessories, and power | |
| | plants, while the aircraft is in the open or in motion. The | |
| | term does not apply to aircraft on any production line or | |
| | in flight. | |
| | (b) Combined regulation/instruction. The Contractor | |
| | shall be bound by the operating procedures contained in | |
| | the combined regulation/instruction entitled | |
| | “Contractor's Flight and Ground Operations” (Air Force | |
| | Instruction 10-220, Army Regulation 95-20, NAVAIR | |
| | Instruction 3710.1 (Series), Coast Guard Instruction | |
| | M13020.3, and Defense Contract Management Agency | |
| | Instruction 8210.1) in effect on the date of contract | |
| | award. | |
| | (c) Government as self-insurer. Subject to the conditions | |
| | in paragraph (d) of this clause, the Government self- | |
| | insures and assumes the risk of damage to, or loss or | |
| | destruction of aircraft “in the open,” during “operation,” | |
| | and in “flight,” except as may be specifically provided in | |
| | the Schedule as an exception to this clause. The | |
| | Contractor shall not be liable to the Government for such | |
| | damage, loss, or destruction beyond the Contractor's | |
| | share of loss amount under the Government's self- | |
| | insurance. | |
| | (d) Conditions for Government's self-insurance. The | |
| | Government's assumption of risk for aircraft in the open | |
| | shall continue unless the Contracting Officerfinds that | |
| | the Contractor has failed to comply with paragraph (b) of | |
| | this clause, or that the aircraft is in the open under | |
| | unreasonable conditions, and the Contractor fails to take | |
| | prompt corrective action. | |
| | (1) The Contracting Officer, when finding that the | |
| | Contractor has failed to comply with paragraph (b) of | |
| | this clause or that the aircraft is in the open under | |
| | unreasonable conditions, shall notify the Contractor in | |
| | writing and shall require the Contractor to make | |
| | corrections within a reasonable time. | |
| | (2) Upon receipt of the notice, the Contractor shall | |
| | promptly correct the cited conditions, regardless of | |
| | whether there is agreement that the conditions are | |
| | unreasonable. | |
| | (i) If the Contracting Officer later determines that the | |
| | cited conditions were not unreasonable, an equitable | |
| | adjustment shall be made in the contract price for any | |
| | additional costs incurred in correcting the conditions. | |
| | (ii) Any dispute as to the unreasonableness of the | |
| | conditions or the equitable adjustment shall be | |
| | considered a dispute under the Disputes clause of this | |
| | contract. | |
| | (3) If the Contracting Officer finds that the Contractor | |
| | failed to act promptly to correct the cited conditions or | |
| | failed to correct the conditions within a reasonable time, | |
| | the Contracting Officer may terminate the Government's | |
| | assumption of risk for any aircraft in the open under the | |
| | cited conditions. The termination will be effective at | |
| | 12:01 a.m. on the fifteenth day following the day the | |
| | written notice is received by the Contractor. | |
| | (i) If the Contracting Officer later determines that the | |
| | Contractor acted promptly to correct the cited conditions | |
| | or that the time taken by the Contractor was not | |
| | unreasonable, an equitable adjustment shall be made in | |
| | the contract price for any additional costs incurred as a | |
| | result of termination of the Government's assumption of | |
| | risk. | |
| | (ii) Any dispute as to the timeliness of the Contractor's | |
| | action or the equitable adjustment shall be considered a | |
| | dispute under the Disputes clause of this contract. | |
| | (4) If the Government terminates its assumption of risk | |
| | pursuant to the terms of this clause- | |
| | (i) The Contractor shall thereafter assume the entire risk | |
| | for damage, loss, or destruction of, the affected aircraft; | |
| | (ii) Any costs incurred by the Contractor (including the | |
| | costs of the Contractor's self-insurance, insurance | |
| | premiums paid to insure the Contractor's assumption of | |
| | risk, deductibles associated with such purchased | |
| | insurance, etc.) to mitigate its assumption of risk are | |
| | unallowable costs; and | |
| | (iii) The liability provisions of the Government Property | |
| | clause of this contract are not applicable to the affected | |
| | aircraft. | |
| | (5) The Contractor shall promptly notify the Contracting | |
| | Officer when unreasonable conditions have been | |
| | corrected. | |
| | (i) If, upon receipt of the Contractor's notice of the | |
| | correction of the unreasonable conditions, the | |
| | Government elects to again assume the risk of loss and | |
| | relieve the Contractor of its liability for damage, loss, or | |
| | destruction of the aircraft, the Contracting Officer will | |
| | notify the Contractor of the Contracting Officer's | |
| | decision to resume the Government's risk of loss.. The | |
| | Contractor shall be entitled to an equitable adjustment in | |
| | the contract price for any insurance costs extending from | |
| | the end of the third working day after the Government's | |
| | receipt of the Contractor notice of correction until the | |
| | Contractor is notified that the Government will resume | |
| | the risk of loss. | |
| | (ii) If the Government does not again assume the risk of | |
| | loss and the unreasonable conditions have been | |
| | corrected, the Contractor shall be entitled to an equitable | |
| | adjustment for insurance costs, if any, extending after the | |
| | third working day after the Government's receipt of the | |
| | Contractor's notice of correction. | |
| | (6) The Government's termination of its assumption of | |
| | risk of loss does not relieve the Contractor of its | |
| | obligation to comply with all other provisions of this | |
| | clause, including the combined regulation/instruction | |
| | entitled “Contractor's Flight and Ground Operations.” | |
| | (e) Exclusions from the Government's assumption of | |
| | risk. The Government's assumption of risk shall not | |
| | extend to damage, loss, or destruction of aircraft which- | |
| | (1) Results from failure of the Contractor, due to willful | |
| | misconduct or lack of good faith of any of the | |
| | Contractor's managerial personnel, to maintain and | |
| | administer a program for the protection and preservation | |
| | of aircraft in the open and during operation in accordance | |
| | with sound industrial practice, including oversight of | |
| | subcontractor's program. | |
| | (2) Is sustained during flight if either the flight or the | |
| | flight crew members have not been approved in advance | |
| | of any flight writing by the Government Flight | |
| | Representative, who has been authorized in accordance | |
| | with the combined regulation/instruction entitled | |
| | “Contractor's Flight and Ground Operations”; | |
| | (3) Occurs in the course of transportation by rail, or by | |
| | conveyance on public streets, highways, or waterways, | |
| | except for Government-furnished property; | |
| | (4) Is covered by insurance; | |
| | (5) Consists of wear and tear; deterioration (including | |
| | rust and corrosion); freezing; or mechanical, structural, | |
| | or electrical breakdown or failure, unless these are the | |
| | result of other loss, damage or destruction covered by | |
| | this clause. (This exclusion does not apply to | |
| | Government-furnished property if damage consists of | |
| | reasonable wear and tear or deterioration, or results from | |
| | inherent vice, e.g., a known condition or design defect, in | |
| | the property); or | |
| | (6) Is sustained while the aircraft is being worked on and | |
| | is a direct result of the work unless such damage, loss, or | |
| | destruction would be covered by insurance which would | |
| | have been maintained by the Contractor, but for the | |
| | Government's assumption of risk. | |
| | (f) Contractor's share of loss and Contractor's deductible | |
| | under the Government's self-insurance. | |
| | (1) The Contractor assumes the risk of loss and shall be | |
| | responsible for the Contractor's share of loss under the | |
| | Government's self-insurance. That share is the lesser | |
| | of- | |
| | (i) The first $100,000 of loss or damage to aircraft in the | |
| | open, during operation, or in flight resulting from each | |
| | separate event, except for reasonable wear and tear and to | |
| | the extent the loss or damage is caused by negligence of | |
| | Government personnel; or | |
| | (ii) Twenty percent of the price or estimated cost of this | |
| | contract. | |
| | (2) If the Government elects to require that the aircraft be | |
| | replaced or restored by the Contractor to its condition | |
| | immediately prior to the damage, the equitable | |
| | adjustment in the price authorized by paragraph (j) of this | |
| | clause shall not include the dollar amount of the risk | |
| | assumed by the Contractor. | |
| | (3) In the event the Government does not elect repair or | |
| | replacement, the Contractor agrees to credit the contract | |
| | price or pay the Government, as directed by the | |
| | Contracting Officer, the lesser of- | |
| | (i) $100,000; | |
| | (ii) Twenty percent of the price or estimated cost of this | |
| | contract; or | |
| | (iii) The amount of the loss. (4) For task order and | |
| | delivery order contracts, the Contractor's share of the | |
| | loss shall be the lesser of $100,000 or twenty percent of | |
| | the combined total price or total estimated cost of those | |
| | orders issued to date to which the clause applies. | |
| | (5) The costs incurred by the Contractor for its share of | |
| | the loss and for insuring against that loss are unallowable | |
| | costs, including but not limited to- | |
| | (i) The Contractor's share of loss under the | |
| | Government's self-insurance; | |
| | (ii) The costs of the Contractor's self-insurance; | |
| | (iii) The deductible for any Contractor-purchased | |
| | insurance; | |
| | (iv) Insurance premiums paid for Contractor- purchased | |
| | insurance; and | |
| | (v) Costs associated with determining, litigating, and | |
| | defending against the Contractor's liability. | |
| | (g) Subcontractor possession or control. The Contractor | |
| | shall not be relieved from liability for damage, loss, or | |
| | destruction of aircraft while such aircraft is in the | |
| | possession or control of its subcontractors, except to the | |
| | extent that the subcontract, with the written approval of | |
| | the Contracting Officer, provides for relief from each | |
| | liability. In the absence of approval, the subcontract shall | |
| | contain provisions requiring the return of aircraft in as | |
| | good condition as when received, except for reasonable | |
| | wear and tear or for the utilization of the property in | |
| | accordance with the provisions of this contract. | |
| | (h) Contractor's exclusion of insurance costs. The | |
| | Contractor warrants that the contract price does not and | |
| | will not include, except as may be authorized in this | |
| | clause, any charge or contingency reserve for insurance | |
| | covering damage, loss, or destruction of aircraft while in | |
| | the open, during operation, or in flight when the risk has | |
| | been assumed by the Government including the | |
| | Contractor's share of loss in this clause, even if the | |
| | assumption may be terminated for aircraft in the open. | |
| | (i) Procedures in the event of loss. | |
| | (1) In the event of damage, loss, or destruction of aircraft | |
| | in the open, during operation, or in flight, the Contractor | |
| | shall take all reasonable steps to protect the aircraft from | |
| | further damage, to separate damaged and undamaged | |
| | aircraft and to put all aircraft in the best possible order. | |
| | Except in cases covered by paragraph (f)(2) of this | |
| | clause, the Contractor shall furnish to the Contracting | |
| | Officer a statement of- | |
| | (i) The damaged, lost, or destroyed aircraft; | |
| | (ii) The time and origin of the damage, loss, or | |
| | destruction; | |
| | (iii) All known interests in commingled property of | |
| | which aircraft are a part; and | |
| | (iv) The insurance, if any, covering the interest in | |
| | commingled property. | |
| | (2) The Contracting Officer will make an equitable | |
| | adjustment for expenditures made by the Contractor in | |
| | performing the obligations under this paragraph. | |
| | (j) Loss prior to delivery. | |
| | (1) If prior to delivery and acceptance by the | |
| | Government, aircraft is damaged, lost, or destroyed and | |
| | the Government assumed the risk, the Government shall | |
| | either- | |
| | (i) Require that the aircraft be replaced or restored by the | |
| | Contractor to the condition immediately prior to the | |
| | damage, in which event the Contracting Officer will | |
| | make an equitable adjustment in the contract price and | |
| | the time for contract performance; or | |
| | (ii) Terminate this contract with respect to the aircraft. | |
| | Notwithstanding the provisions in any other termination | |
| | clause under this contract, in the event of termination, the | |
| | Contractor shall be paid the contract price for the aircraft | |
| | (or, if applicable, any work to be performed on the | |
| | aircraft) less any amount the Contracting Officer | |
| | determines- | |
| | (A) It would have cost the Contractor to complete the | |
| | aircraft (or any work to be performed on the aircraft) | |
| | together with anticipated profit on uncompleted work; | |
| | and | |
| | (B) Would be the value of the damaged aircraft or any | |
| | salvage retained by the Contractor. | |
| | (2) The Contracting Officer shall prescribe the manner of | |
| | disposition of the damaged, lost, or destroyed aircraft, or | |
| | any parts of the aircraft. If any additional costs of such | |
| | disposition are incurred by the Contractor, a further | |
| | equitable adjustment will be made in the amount due the | |
| | Contractor. Failure of the parties to agree upon | |
| | termination costs or an equitable adjustment with respect | |
| | to any aircraft shall be considered a dispute under the | |
| | Disputes clause. | |
| | (k) Reimbursement from a third party. In the event the | |
| | Contractor is reimbursed or compensated by a third party | |
| | for damage, loss, or destruction of aircraft and has also | |
| | been compensated by the Government, the Contractor | |
| | shall equitably reimburse the Government. The | |
| | Contractor shall do nothing to prejudice the | |
| | Government's right to recover against third parties for | |
| | damage, loss, or destruction. Upon the request of the | |
| | Contracting Officer or authorized representative, the | |
| | Contractor shall at Government expense furnish to the | |
| | Government all reasonable assistance and cooperation | |
| | (including the prosecution of suit and the execution of | |
| | instruments of assignment or subrogation) in obtaining | |
| | recovery. | |
| | (1) Government acceptance of liability. To the extent the | |
| | Government has accepted such liability under other | |
| | provisions of this contract, the Contractor shall not be | |
| | reimbursed for liability to third persons for loss or | |
| | damage to property or for death or bodily injury caused | |
| | by aircraft during flight unless the flight crew members | |
| | previously have been approved for this flight in writing | |
| | by the Government Flight Representative, who has been | |
| | authorized in accordance with the combined regulation | |
| | entitled “Contractor's Flight and Ground Operations”. | |
| | (m) Subcontracts. The Contractor shall incorporate the | |
| | requirements of this clause, including this paragraph (m), | |
| | in all subcontracts. | |
| Clause92 | 252.234-7002 Earned Value Management System April 2008 | |
| | (1) Greater than $50M subcontract value - whole clause | |
| | applies; | |
| | (2) Less than $50M subcontract value exclude paragraph | |
| | (b) of clause from applicability. | |
| Clause93 | 252.235-7003 Frequency Authorization (December 1991) - | Is this procurement |
| | Alternate I August 2008 | involving |
| | | development, test, or |
| | | operation of a device |
| | | for which a |
| | | frequency |
| | | authorization is |
| | | required? |
| Clause94 | 252.236-7013 Requirement for Competition Opportunity | Does this |
| | for American Steel Producers, Fabricators, and | procurement involve |
| | Manufacturers (Pub. L. 110-329, Division E, Section | the acquisition of |
| | 108). | steel as a |
| | | construction |
| | | material? |
| Clause95 | 252.244-7000 Subcontracts for Commercial Items and | |
| | Commercial Components (DoD Contracts) | |
| | (August 2009). | |
| Clause96 | 252.246-7000 Material Inspection And Receiving Report | Is it required for the |
| | March 2008 | supplier to issue |
| | | receiving reports via |
| | | WAWF for their |
| | | direct ship deliveries |
| | | to the government? |
| Clause97 | 252.246-7001 Warranty Of Data December 1991 | |
| Clause98 | 252.246-7003 Notification of Potential Safety Issues | |
| | January 2007 | |
| Clause99 | 252.247-7023 Transportation of Supplies by Sea (MAY | |
| | 2002). This clause applies only if the supplies are of a | |
| | type described in paragraph (b)(2) of this clause. In | |
| | paragraph (d), “45 days” is changed to “60 days.”In | |
| | paragraph (g) “Government” means Buyer. If this | |
| | contract is at or below $100,000, paragraphs (f) and (g) | |
| | are excluded. | |
| Clause100 | 252.247-7024 Notification Of Transportation Of | |
| | Supplies By Sea (March 2000) (10 USC 2631) | |
| Clause101 | 252.249-7002 Notification Of Anticipated Contract | $100K |
| | Termination Or Reduction (DECEMBER 2006). This clause | |
| | applies only if this contract is $100,000 or more. Seller | |
| | will comply with the notice and flowdown requirements | |
| | of paragraph (d)(2) of the referenced clause. | |
| Clause103 | 3. Commercial Items If goods or services being | |
| | procured under this contract are commercial items | |
| | and Clause H203 is set forth in the purchase order, | |
| | the foregoing Government clauses in Sections 1 and 2 | |
| | above are deleted and the following FAR/DFARS | |
| | clauses are inserted in lieu thereof: | |
| | H203: SUBCONTRACT FOR COMMERCIAL | |
| | ITEMS AND COMMERCIAL COMPONENTS | |
| | This procurement is for commercial items and/or | |
| | commercial components, as defined in the Federal | |
| | Acquisition Regulations (FAR), under a Government | |
| | contract. | |
| Clause104 | 52.203-13 Contractor Code of Business Ethics and | Duplicat see 7 |
| | Conduct (DECEMBER 2008). This clause applies only if this | |
| | contract is in excess of $5,000,000 and has a period of | |
| | performance of more than 120 days. | |
| Clause105 | 52.219-8 Utilization of Small Business Concerns (MAY | DUPLICATE |
| | 2004). | |
| Clause106 | 52.222-26 Equal Opportunity (MARCH 2007). | DUPLICATE |
| Clause107 | 52.222-35 Equal Opportunity for Special Disabled | DUPLICATE |
| | Veterans, Veterans of the Vietnam Era, and Other | |
| | Eligible Veterans (SEPTEMBER 2006). | |
| Clause108 | 52.222-36 Affirmative Action For Workers With | DUPLICATE |
| | Disabilities (JUNE 1998). | |
| Clause109 | 52.222-39 Notification of Employee Rights Concerning | DUPLICATE |
| | Payment of Union Dues or Fees (DECEMBER 2004). | |
| Clause110 | 52.222-50 Combating Trafficking in Persons (FEBRUARY | DUPLICATE |
| | 2009). | |
| Clause111 | 4. Cost Accounting Standards | DUPLICATE |
| Clause112 | 52.230-2 Cost Accounting Standards (OCTOBER 2008). | DUPLICATE |
| | (1) (Applicable if this contract incorporates the following | |
| | clause H001). The version of FAR 52.230-2, Cost | |
| | Accounting Standards, incorporated by the above clause | |
| | H001 is the version dated October 2008. | |
| | H001: The clause entitled “Cost Accounting Standards,” | |
| | FAR 52.230-2, excluding paragraph (b), is incorporated | |
| | herein by reference. In this clause, “Contractor” shall | |
| | mean Seller, and any reference to “disputes” or the | |
| | “Contract Disputes Act” shall mean the Disputes clause | |
| | of this contract. The version of FAR 52.230-2 | |
| | incorporated in this contract is stated in the Cost | |
| | Accounting Standards article of the Customer Contract | |
| | Requirements (CCR) incorporated in this contract. | |
| | (2) (Applicable if this contract incorporates the following | |
| | clause H002) The version of FAR 52.230-3, | |
| | Disclosure and Consistency of Cost Accounting | |
| | Practices, incorporated by the following H0002 clause is | |
| | the version dated October 2008. | |
| | H002: DISCLOSURE AND CONSISTENCY IN COST | |
| | ACCOUNTING PRACTICES | |
| | The clause entitled “Disclosure and Consistency in Cost | |
| | Accounting Practices,” FAR 52.230-3, excluding | |
| | paragraph (b), is incorporated herein by reference. In this | |
| | clause, “Contractor” shall mean Seller, and any reference | |
| | to “disputes” or the “Contract Disputes Act” shall mean | |
| | the Disputes clause of this contract. The version of FAR | |
| | 52.230-3 incorporated in this contract is stated in the | |
| | Cost Accounting Standards article of the Customer | |
| | Contract Requirements (CCR) incorporated in this | |
| | contract. | |
| | (3) (Applicable if this contract incorporates clause H003) | |
| | The version of FAR 52.230-5, Cost Accounting | |
| | Standards - Educational Institution, is the version dated | |
| | October 2008. | |
| | H003: CONSISTENCY IN COST ACCOUNTING | |
| | PRACTICES | |
| | The clause entitled “Consistency in Cost Accounting | |
| | Practices,” FAR 52.230-4, is incorporated herein by | |
| | reference. In this clause, “Contractor” shall mean Seller. | |
| | The version of FAR 52.230- 4 incorporated in this | |
| | contract is stated in the Cost Accounting Standards | |
| | article of the Customer Contract Requirements (CCR) | |
| | incorporated in this contract. | |
| | (4) (Applicable if this contract incorporates clause H007) | |
| | The version of FAR 52.230-4, Disclosure and | |
| | Consistency of Cost Accounting Standards for Contracts | |
| | Awarded to Foreign Concerns, is the version dated | |
| | October 2008. | |
| | H007: DISCLOSURE AND CONSISTENCY OF | |
| | COST ACCOUNTING PRACTICES FOR | |
| | CONTRACTS AWARDED TO FOREIGN | |
| | CONCERNS | |
| | The clause entitled “Disclosure and Consistency of Cost | |
| | Accounting Practices for Contracts Awarded to Foreign | |
| | Concerns,” FAR 52.230-4, is incorporated herein by | |
| | reference. In this clause, “Contractor” shall mean Seller. | |
| | The version of FAR 52.230-4 incorporated in this | |
| | contract is stated in the Cost Accounting Standards | |
| | article of the Customer Contract Requirements (CCR) | |
| | incorporated in this contract. | |
| Clause113 | 5. NAVAIR Clauses The following contract clauses | Always |
| | are incorporated by reference from the Naval Air | |
| | Systems Command Federal Acquisition Regulation | |
| | Supplement and apply to the extent indicated. | |
| Clause114 | 5252.204-9504 DISCLOSURE OF CONTRACT | Always |
| | INFORMATION (NAVAIR) (JANUARY 2007) | |
| Clause115 | 5252.210-9501 AVAILABILITY OF UNIQUE DATA | |
| | ITEM DESCRIPTIONS (UDIDs) AND DATA ITEM | |
| | DESCRIPTIONS (DIDs) (NAVAIR) (OCTOBER 2005) | |
| Clause116 | 5252.222-9502 PROHIBITION AGAINST HUMAN | Will the supplier be |
| | TRAFFICKING, INHUMANE LIVING CONDITIONS, | deploying any |
| | AND WITHHOLDING OF EMPLOYEE PASSPORTS | individuals overseas |
| | (JCC-I/A 952.222-0001)(AUGUST 2009) | during the duration |
| | (a) All contractors (“contractors” refers to both prime | of this contract? |
| | contractors and all subcontractors at all tiers) are | |
| | reminded of the prohibition contained in Title 18, United | |
| | States Code, Section 1592, against knowingly destroying, | |
| | concealing, removing, confiscating, or possessing any | |
| | actual or purported passport or other immigration | |
| | document, or any other actual or purported government | |
| | identification document, of another person, to prevent or | |
| | restrict or to attempt to prevent or restrict, | |
| | without lawful authority, the person's liberty to move | |
| | or travel, in order to maintain the labor or services of that | |
| | person, when the person is or has been a victim of a | |
| | severe form of trafficking in persons. | |
| | (b) Contractors are also required to comply with the | |
| | following provisions: | |
| | (1) Contractors shall only hold employee passports and | |
| | other identification documents discussed above for the | |
| | shortest period of time reasonable for administrative | |
| | processing purposes. | |
| | (2) Contractors shall provide all employees with a signed | |
| | copy of their employment contract, in English as well | |
| | as the employee's native language that defines the terms | |
| | of their employment/compensation. | |
| | (3) Contractors shall not utilize unlicensed recruiting | |
| | firms, or firms that charge illegal recruiting fees. | |
| | (4) Contractors shall be required to provide adequate | |
| | living conditions (sanitation, health, safety, living space) | |
| | for their employees. Fifty square feet is the minimum | |
| | acceptable square footage of personal living space per | |
| | employee. Upon contractor's written request, contracting | |
| | officers may grant a waiver in writing in cases where the | |
| | existing square footage is within 20% of the minimum, | |
| | and the overall conditions are determined by the | |
| | contracting officer to be acceptable. A copy of the waiver | |
| | approval shall be maintained at the respective life | |
| | support area. | |
| | (5) Contractors shall incorporate checks of life support | |
| | areas to ensure compliance with the requirements of this | |
| | Trafficking in Persons Prohibition into their Quality | |
| | Control program, which will be reviewed within the | |
| | Government's Quality Assurance process. | |
| | (6) Contractors shall comply with international laws | |
| | regarding transit/exit/entry procedures, and the | |
| | requirements for work visas. Contractors shall follow all | |
| | Host Country entry and exit requirements, including | |
| | requirements for visas and work permits. | |
| | (c) Contractors have an affirmative duty to advise the | |
| | Contracting Officer if they learn of their employees | |
| | violating the human trafficking and inhumane living | |
| | conditions provisions contained herein. Contractors are | |
| | advised that contracting officers and/or their | |
| | representatives will conduct random checks to ensure | |
| | contractors and subcontractors at all tiers are adhering to | |
| | the law on human trafficking, humane living conditions | |
| | and withholding of passports. | |
| | (d) The contractor agrees to incorporate the substance of | |
| | this clause, including this paragraph, in all subcontracts | |
| | under his contract. | |
| Clause117 | 5252.223-9502 HAZARDOUS MATERIAL | Same as clause 36 |
| | (NAVAIR)(APRIL 2009) | |
| Clause118 | 5252.223-9503 REPORTING KIDNAPPINGS, | |
| | SERIOUS INJURIES AND DEATHS (JCC-I/A | |
| | 952.223-0001) (JULY 2010) | |
| | Report the following information: | |
| | Contract Number: Contract Description & Location, | |
| | Company Name | |
| | Reporting party: Name, Phone number, E-mail address | |
| | Victim: Name, Gender (Male/Female), Age, Nationality, | |
| | Country of permanent residence | |
| | Incident: Description, Location, Date and time | |
| | Other Pertinent Information | |
| Clause119 | 5252.225-9507 CONTRACT DELIVERY | |
| | REQUIREMENTS (JCC-I/A 952.225-0006)(MARCH 2009) | |
| Clause120 | 5252.225-9508 MANDATORY SHIPPING | Is the supplier in the |
| | INSTRUCTIONS (IRAQ) (JCC-I/A 952.225-0007)(FEBRUARY | United States Forces - |
| | 2010) 5252.225-9510 COMPLIANCE WITH LAWS | Iraq or the United |
| | AND REGULATIONS (JCC -I/A 952.225-0004) (JULY | States Forces - |
| | 2010) | Afghanistan theater |
| | (a) The Contractor shall comply with, and shall ensure | of operations? |
| | that its employees and its subcontractors and their | |
| | employees, at all tiers, are aware of and obey all U.S. and | |
| | Host Nation laws, Federal or DoD regulations, and | |
| | Central Command orders and directives applicable to | |
| | personnel in Iraq and Afghanistan, including but not | |
| | limited to USCENTCOM, Multi-National Force and | |
| | Multi-National Corps operations and fragmentary orders, | |
| | instructions, policies and directives. | |
| | (b) Contractor employees shall particularly note all laws, | |
| | regulations, policies, and orders restricting authority to | |
| | carry firearms, rules for the use of force, and prohibiting | |
| | sexual or aggravated assault. Contractor employees are | |
| | subject to General Orders Number 1, as modified from | |
| | time to time, including without limitation, their | |
| | prohibition on privately owned firearms, alcohol, drugs, | |
| | war souvenirs, pornography and photographing | |
| | detainees, human casualties or military security | |
| | measures. | |
| | (c) Contractor employees may be ordered removed from | |
| | secure military installations or the theater of operations | |
| | by order of the senior military commander of the battle | |
| | space for acts that disrupt good order and discipline or | |
| | violate applicable laws, regulations, orders, instructions, | |
| | policies, or directives. Contractors shall immediately | |
| | comply with any such order to remove its contractor | |
| | employee. | |
| | (d) Contractor employees performing in the | |
| | USCENTCOM Area of Responsibility (AOR) may be | |
| | subject to the jurisdiction of overlapping criminal codes, | |
| | including, but not limited to, the Military Extraterritorial | |
| | Jurisdiction Act (18 U.S.C. Sec. 3261, et al) (MEJA), the | |
| | Uniform Code of Military Justice (10 U.S.C. Sec. 801, et | |
| | al)(UCMJ), and the laws of the Host Nation. Non-US | |
| | citizens may also be subject to the laws of their home | |
| | country while performing in the USCENTCOM AOR. | |
| | Contractor employee status in these overlapping criminal | |
| | jurisdictions may be modified from time to time by the | |
| | United States, the Host Nation, or by applicable status of | |
| | forces agreements. | |
| | (e) Under MEJA, a person who engages in felony | |
| | misconduct outside the United States while employed by | |
| | or accompanying the Armed Forces is subject to arrest, | |
| | removal and prosecution in United States federal courts. | |
| | Under the UCMJ, a person serving with or | |
| | accompanying the Armed Forces in the field during a | |
| | declared war or contingency operation may be | |
| | disciplined for a criminal offense, including by referral of | |
| | charges to a General Court Martial. Contractor | |
| | employees may be ordered into confinement or placed | |
| | under conditions that restrict movement within the AOR | |
| | or administratively attached to a military command | |
| | pending resolution of a criminal investigation. | |
| | (f) Contractors shall immediately notify military law | |
| | enforcement and the Contracting Officer if they suspect | |
| | an employee has committed an offense. Contractors shall | |
| | take any and all reasonable and necessary measures to | |
| | secure the presence of an employee suspected of a | |
| | serious felony offense. Contractors shall not knowingly | |
| | facilitate the departure of an employee suspected of a | |
| | serious felony offense or violating the Rules for the Use | |
| | of Force to depart Iraq or Afghanistan without approval | |
| | from the senior U.S. commander in the country. | |
| Clause121 | 5252.225-9514 ARMED PERSONNEL INCIDENT | Is the supplier in the |
| | REPORTS (JCC-I/A 952.225-0002)(SEPTEMBER 2010) | United States Forces - |
| | (a) All contractors and subcontractors in the United | Iraq or the United |
| | States Forces-Iraq (USF-I) or United States Forces- | States Forces - |
| | Afghanistan (USFOR-A) theater of operations shall | Afghanistan theater |
| | comply with and shall ensure that their personnel | of operations? |
| | supporting USF-I or USFOR-A forces are familiar with | |
| | and comply with all applicable orders, directives, and | |
| | instructions issued by the respective USF-I or USFOR-A | |
| | Commanders relating to force protection and safety. | |
| | (b) IRAQ: Contractors shall provide all incidents and use | |
| | of weapons firing incidents to the USF-I Contractor | |
| | Operations Cell (CONOC) as soon as practical, based | |
| | upon the situation, and submit a written report to | |
| | CONOC within 4 hours. The initial report shall include | |
| | the name of the company, location of the incident, time | |
| | when the incident occurred, a brief description of the | |
| | events leading up to the incident, and a company point of | |
| | contact. A follow-up, comprehensive written report shall | |
| | be provided to the CONOC within 96 hours of the | |
| | incident. Reports shall be submitted to CONOC at: | |
| | mncic3conoc@iraq.centcom.mil;, DSN 318-435-2369; | |
| | Iraqna 0044 203 286 9851 or 0044 203 239 5894; or | |
| | Skype: MNCICONOC. | |
| | (c) AFGHANISTAN: Contractors shall immediately | |
| | report all incidents and use of weapons through their | |
| | Contracting Officers Representative (CORs) who will | |
| | notify the Contracting Officer. Contracting Officers are | |
| | responsible to notify the PARC-A Chief of Operations | |
| | and the JOC @ USFOR-A (JOC SHIFT DIRECTOR, | |
| | DSN: 318-237-1761) Information should include: the | |
| | name of the company, where the incident occurred, time | |
| | when the incident occurred, a brief description of the | |
| | events leading up to the incident, and a point of contact | |
| | for the company. The PARC-A Chief of Operations in | |
| | coordination with the JOC will issue guidance for further | |
| | reporting requirements. | |
| | (d) Contractors shall provide first aid and request | |
| | MEDEVAC of injured persons, and remain available for | |
| | U.S. or Coalition response forces, based upon the | |
| | situation. In the event contractor personnel are detained | |
| | by U.S. or Coalition Forces, prolonged detention due to | |
| | lack of proper identification can be alleviated by | |
| | contractor personnel possessing on their person | |
| | information that includes the contractor's name, the | |
| | contract number, a contractor management POC, and the | |
| | phone number of the CONOC/JOC Watch. | |
| Clause122 | 5252.225-9515 FITNESS FOR DUTY AND | Will the supplier be |
| | MEDICAL/DENTAL CARE LIMITATIONS | deploying any |
| | (JCC-I/A 952.225-0003)(JULY 2010) | individuals overseas |
| | (a) The contractor shall perform the requirements of this | during the duration |
| | contract notwithstanding the fitness for duty of deployed | of this contract? |
| | employees, the provisions for care offered under this | |
| | section, and redeployment of individuals determined to | |
| | be unfit. The contractor bears the responsibility for | |
| | ensuring all employees are aware of the conditions and | |
| | medical treatment available at the performance location. | |
| | The contractor shall include this information and | |
| | requirement in all subcontracts with performance in the | |
| | theater of operations. | |
| | (b) The contractor shall not deploy an individual with | |
| | any of the following conditions unless approved by the | |
| | appropriate CENTCOM Service Component (i.e. | |
| | ARCENT, AFCENT, etc.) Surgeon: Conditions which | |
| | prevent the wear of personal protective equipment, | |
| | including protective mask, ballistic helmet, body armor, | |
| | and chemical/biological protective garments; conditions | |
| | which prohibit required theater immunizations or | |
| | medications; conditions or current medical treatment or | |
| | medications that contraindicate or preclude the use of | |
| | chemical and biological protective's and antidotes; | |
| | diabetes mellitus, Type I or II, on pharmacological | |
| | therapy; symptomatic coronary artery disease, or with | |
| | myocardial infarction within one year prior to | |
| | deployment, or within six months of coronary artery | |
| | bypass graft, coronary artery angioplasty, or stenting; | |
| | morbid obesity (BMI >/= 40); dysrhythmias or | |
| | arrhythmias, either symptomatic or requiring medical or | |
| | electrophysiological control; uncontrolled hypertension, | |
| | current heart failure, or automatic implantable | |
| | defibrillator; therapeutic anticoagulation; malignancy, | |
| | newly diagnosed or under current treatment, or recently | |
| | diagnosed/treated and requiring frequent subspecialist | |
| | surveillance, examination, and/or laboratory testing; | |
| | dental or oral conditions requiring or likely to require | |
| | urgent dental care within six months' time, active | |
| | orthodontic care, conditions requiring prosthodontic care, | |
| | conditions with immediate restorative dentistry needs, | |
| | conditions with a current requirement for oral- | |
| | maxillofacial surgery; new onset (<1 year) seizure | |
| | disorder, or seizure within one year prior to deployment; | |
| | history of heat stroke; Meniere's Disease or other | |
| | vertiginous/motion sickness disorder, unless well | |
| | controlled on medications available in theater; recurrent | |
| | syncope, ataxias, new diagnosis (<1 year) of mood | |
| | disorder, thought disorder, anxiety, somatoform, or | |
| | dissociative disorder, or personality disorder with mood | |
| | or thought manifestations; unrepaired hernia; | |
| | tracheostomy or aphonia; renalithiasis, current; active | |
| | tuberculosis; pregnancy; unclosed surgical defect, such | |
| | as external fixeter placement; requirement for medical | |
| | devices using AC power; HIV antibody positivity; | |
| | psychotic and bipolar disorders. (Reference: Mod 8 to | |
| | USCENTCOM Individual Protection and Individual/Unit | |
| | Deployment Policy, PPG-Tab A: Amplification of the | |
| | Minimal Standards of Fitness for Deployment to the | |
| | CENTCOM AOR). | |
| | (c) In accordance with military directives (DoDI | |
| | 3020.41, DoDI 6000.11, CFC FRAGO 09-1038, DoD | |
| | PGI 225.74), resuscitative care, stabilization, | |
| | hospitalization at Level III (emergency) military | |
| | treatment facilities and assistance with patient movement | |
| | in emergencies where loss of life, limb or eyesight could | |
| | occur will be provided. Hospitalization will be limited to | |
| | emergency stabilization and short-term medical treatment | |
| | with an emphasis on return to duty or placement in the | |
| | patient movement system. Subject to availability at the | |
| | time of need, a medical treatment facility may provide | |
| | reimbursable treatment for emergency medical or dental | |
| | care such as broken bones, lacerations, broken teeth or | |
| | lost fillings. | |
| | (d) Routine and primary medical care is not authorized. | |
| | Pharmaceutical services are not authorized for routine or | |
| | known, routine prescription drug needs of the individual. | |
| | Routine dental care, examinations and cleanings are not | |
| | authorized. | |
| | (e) Notwithstanding any other provision of the contract, | |
| | the contractor shall be liable for any and all medically- | |
| | related services or transportation rendered. To view | |
| | reimbursement rates that will be charged for services at | |
| | all DoD deployed medical facilities please go to the | |
| | following website: | |
| | http://comptroller.defense.gov/rates/fy2010.html (change | |
| | fiscal year as applicable). | |
| Clause123 | 5252.225-9516 MONTHLY CONTRACTOR CENSUS | Required for all |
| | REPORTING (JCC-I/A 952.225-0005)(JULY 2010) | suppliers |
| | Contractor shall provide monthly employee census | |
| | information to the Contracting Officer, by province, for | |
| | this contract. Information shall be submitted either | |
| | electronically or by hard-copy. Information shall be | |
| | current as of the 25th day of each month and received by | |
| | the Contracting Officer no later than the first day of the | |
| | following month. The following information shall be | |
| | provided for each province in which work was | |
| | performed: | |
| | (1) The total number (prime and subcontractors at all | |
| | tiers) employees. | |
| | (2) The total number (prime and subcontractors at all | |
| | tiers) of U.S. citizens. | |
| | (3) The total number (prime and subcontractors at all | |
| | tiers) of local nationals (LN). | |
| | (4) The total number (prime and subcontractors at all | |
| | tiers) of third-country nationals (TCN). | |
| | (5) Name of province in which the work was performed. | |
| | (6) The names of all company employees who enter and | |
| | update employee data in the Synchronized | |
| | Predeployment & Operational Tracker (SPOT) IAW | |
| | DFARS 252.225-7040 or DFARS DOD class deviation | |
| | 2007-O0010. | |
| Clause124 | 5252.225-9518 ARMING REQUIREMENTS AND | |
| | PROCEDURES FOR PERSONAL SECURITY | |
| | SERVICES CONTRACTORS AND FOR REQUESTS | |
| | FOR PERSONAL PROTECTION | |
| | (JCC-I/I 952.225-0001)(AUGUST 2010) | |
| | (a) General. Contractor and its subcontractors at all tiers | |
| | that require arming under this contract agree to obey all | |
| | laws, regulations, orders, and directives applicable to the | |
| | use of private security personnel in Iraq and Afghanistan, | |
| | including U.S. CENTCOM, United States Forces - Iraq | |
| | (USF-I) and United States Forces - Afghanistan | |
| | (USFOR-A) Commander orders, instructions and | |
| | directives. Contractors will ensure that all employees, | |
| | including employees at any tier of subcontracting | |
| | relationships, who will seek individual authorization to | |
| | be armed under the provisions of this contract (requests | |
| | for blanket authorization for groups or organizations will | |
| | not be approved), comply with the contents of this | |
| | clause and with the requirements set forth in the | |
| | following: | |
| | (1) DODI 3020.50, Private Security Contractors (PSCs) | |
| | Operating in Contingency Operations; | |
| | (2) DODI 3020.41, Program Management for | |
| | Acquisition and Operational Contract Support in | |
| | Contingency Operations; | |
| | (3) DFARS 252.225-7040, Contractor Personnel | |
| | Supporting a Force Deployed Outside the United States; | |
| | (4) Class Deviation 2007-O0010, Contractor Personnel in | |
| | the United States Central Command Area of | |
| | Responsibility | |
| | (5) USFOR-A, FRAGO 09-206, Outlines Management | |
| | of Armed Contractors and Private Security Companies | |
| | Operating in the Combined Joint Operating Area - | |
| | Afghanistan (CJOA-A) | |
| | (6) USF-I OPORD 10-01, Annex C, Appendix 13 | |
| | (7) U.S. CENTCOM Message, USCENTCOM Policy | |
| | and Delegation of Authority for Personal Protection and | |
| | Contract Security Service Arming of DoD Civilian | |
| | Personnel and Contractors for Iraq and Afghanistan, | |
| | dated 23 Dec. 2005 | |
| | (8) U.S. CENTCOM Message, Modification to | |
| | USCENTCOM Civilian and Contractor Arming Policy | |
| | and Delegation of Authority for Iraq and Afghanistan, | |
| | dated 7 Nov. 2006 | |
| | (9) U.S. CENTCOM Message, Modification 3 to | |
| | USCENTCOM Civilian and Contractor Arming Policy | |
| | and Delegation of Authority in Iraq and Afghanistan, | |
| | dated 9 Jun. 2009 | |
| | (b) Required Government Documentation. An O-6 or | |
| | GS-15 (or above) from the unit requesting the contractor | |
| | security shall provide a description of the following to | |
| | the arming approval authority via the contracting officer | |
| | representative (COR) in sponsoring each individual | |
| | request for arming (under paragraph (c) below: | |
| | (1) The specific location where the PSC employee will | |
| | operate; | |
| | (2) The persons and/or property that require protection; | |
| | (3) The anticipated threat; | |
| | (4) The requested weapon type(s), including serial | |
| | number when possible; | |
| | (5) The reason current security/police forces are unable | |
| | to provide adequate protection; and | |
| | (6) Verification, under paragraph (e) below, that | |
| | background checks have been conducted and that no | |
| | records were found of convictions or other acts that | |
| | should be known to the arming authority. | |
| | (c) Required Contractor Documentation. Contractors and | |
| | their subcontractors at all tiers that require arming | |
| | approval shall provide to the arming approval authority | |
| | via the COR consistent documentation (signed and dated | |
| | by the employee and employer as applicable) for each of | |
| | their employees who will seek authorization to be armed | |
| | under the contract as follows: | |
| | (1) Weapons Qualification/Familiarization. All | |
| | employees must meet the weapons qualification | |
| | requirements on the requested weapon(s) established by | |
| | any DoD or other U.S. government agency, Law of | |
| | Armed Conflict (LOAC); Rules for the Use of Force | |
| | (RUF), as defined in the U.S. CENTCOM Policy, dated | |
| | 23 Dec. 2005; and distinction between the above- | |
| | prescribed RUF and the Rules of Engagement (ROE), | |
| | which are applicable only to military forces. | |
| | (2) Completed DD Form 2760 (or equivalent | |
| | documentation) for each armed employee, indicating that | |
| | the employee is not otherwise prohibited under U.S. law | |
| | from possessing the required weapon or ammunition. | |
| | (3) Written acknowledgement by the individual of the | |
| | fulfillment of training responsibilities and the conditions | |
| | for the authorization to carry firearms. This document | |
| | includes the acknowledgement of the distinctions | |
| | between the ROE applicable to military forces and RUF | |
| | that control the use of weapons by DoD civilians, DoD | |
| | contractors and PSCs. | |
| | (4) Written acknowledgement signed by both the armed | |
| | employee and by a representative of the employing | |
| | company that use of weapons could subject both the | |
| | individual and company to U.S. and host nation | |
| | prosecution and civil liability. | |
| | (5) A copy of the contract between the contractor's | |
| | company and the U.S. Government that verifies the | |
| | individual's employment and addresses the need to be | |
| | armed. | |
| | (6) One (1) copy of a business license from the Iraqi or | |
| | Afghani Ministry of Trade or Interior; | |
| | (7) One (1) copy of a license to operate as a PSC (or a | |
| | temporary operating license) from the Ministry of | |
| | Interior; | |
| | (d) The contractor will submit to the COR a | |
| | communications plan that, at a minimum, sets forth the | |
| | following: | |
| | (1) The contractor's method of notifying military forces | |
| | and requesting assistance where hostilities arise, combat | |
| | action is needed or serious incidents have been observed; | |
| | (2) How relevant threat information will be shared | |
| | between contractor security personnel and U.S. military | |
| | forces; and | |
| | (3) How the contractor will coordinate transportation | |
| | with appropriate military authorities. | |
| | (e) Prior to requesting arming approval, the contractor | |
| | will submit to the COR an acceptable plan for | |
| | accomplishing background checks on all contractor and | |
| | subcontractor employees who will be armed under the | |
| | contract. The contractor shall, at a minimum, perform the | |
| | following (which will be specifically addressed in its | |
| | plan and which will be documented and furnished to the | |
| | COR upon completion): | |
| | (1) Use one or more of the following sources when | |
| | conducting the background checks: Interpol, FBI, | |
| | Country of Origin Criminal Records, Country of Origin | |
| | U.S. Embassy Information Request, CIA records, and/or | |
| | any other records available; | |
| | (2) Verify with USF-I or USFOR-A, as applicable, that | |
| | no employee has been barred by any commander within | |
| | Iraq or Afghanistan; and | |
| | (3) All local nationals and third country nationals will | |
| | voluntarily submit to full biometric enrollment in | |
| | accordance with theater biometric policies within 60 days | |
| | of their arming request. While biometric collection and | |
| | screening is voluntary, CORs will immediately notify the | |
| | arming approval authority of any individuals who do not | |
| | meet this requirement and any arming authorization will | |
| | be revoked until all requirements are met. | |
| | (f) Penalties for Non-Compliance. Failure of contractor | |
| | or subcontractor employee(s) to comply with the laws, | |
| | regulations, orders, and rules (including those specified | |
| | herein) governing the use of force, training, arming | |
| | authorization, and incident reporting requirements may | |
| | result in the revocation of weapons authorization for such | |
| | employee(s). Where appropriate, such failure may also | |
| | result in the total revocation of weapons authorization for | |
| | the contractor (or subcontractor) and sanctions under the | |
| | contract, including termination. | |
| | (g) Criminal and Civil Liability. Arming of contractor or | |
| | subcontractor employees under this contract may subject | |
| | the contractor, its subcontractors, and persons employed | |
| | by the same, to the civil and criminal jurisdiction of the | |
| | U.S. and Host Nation. “Host Nation” refers to the nation | |
| | or nations where services under this contract are | |
| | performed. | |
| | (h) Lapses in Training or Authorization. Failure to | |
| | successfully retrain an employee who has been properly | |
| | authorized to be armed under this contract within twelve | |
| | (12) months of the last training date will constitute a | |
| | lapse in the employee's authorization to possess and | |
| | carry the weapon. All unauthorized employees will | |
| | immediately surrender their weapon and authorization | |
| | letter to the contractor and will remain unarmed until | |
| | such time as they are retrained and newly approved by | |
| | the arming authority. Additionally, the arming | |
| | authority's authorization letter is valid for a maximum of | |
| | twelve (12) months from the date of the prior letter | |
| | (unless authorization is earlier invalidated by a lapse in | |
| | training). | |
| | (i) Authorized Weapon & Ammunition Types. Unless | |
| | DCDRUSCENTCOM (or a designee) expressly provides | |
| | otherwise, all arming requests and authorizations for | |
| | contractor or subcontractor employees under this contract | |
| | shall be limited to U.S. Government-approved weapons | |
| | and ammunition. Notwithstanding Host Nation laws or | |
| | regulations that would allow use of heavier weapons by | |
| | contract security/PSC, all DoD security service/PSC | |
| | contractors must have weapons approved by | |
| | DCDRUSCENTCOM (or a designee) before use. This | |
| | restriction applies to all weapons in the possession of | |
| | contractor employees, even if such weapons are required | |
| | for personal protection. The following weapons and | |
| | ammunition are currently authorized by the U.S. | |
| | Government for use in Iraq and Afghanistan: | |
| | (1) The M9, M4, M16, or equivalent (e.g. .45 CAL, AK- | |
| | 47). | |
| | (2) The M9 or equivalent sidearm will be the standard | |
| | personal protection weapon unless other weapons are | |
| | specifically requested and approved. | |
| | (3) U.S. government Ball ammunition is the standard | |
| | approved ammunition. | |
| | (j) Requirements for Individual Weapons Possession. All | |
| | employees of the contractor and its subcontractors at all | |
| | tiers who are authorized to be armed under this contract | |
| | must: | |
| | (1) Possess only those U.S. Government-approved | |
| | weapons and ammunition for which they are qualified | |
| | under the training requirements of section (c) and | |
| | subsequently authorized to carry; | |
| | (2) Carry weapons only when on duty or at a specific | |
| | post (according to their authorization); | |
| | (3) Not conceal any weapons, unless specifically | |
| | authorized; | |
| | (4) Carry proof of authorization to be armed. Employees | |
| | not possessing such proof will be deemed unauthorized | |
| | and must surrender their weapon to their employer; and | |
| | (5) IAW USCENTCOM G.O. #1, consumption of | |
| | alcohol in Iraq or Afghanistan is prohibited. In the event | |
| | of a suspension or an exception to G.O. #1, employees | |
| | shall not consume any alcoholic beverage while armed or | |
| | within eight (8) hours of the next work period when they | |
| | will be armed. There are no circumstances under which a | |
| | person will be authorized to consume any alcoholic | |
| | beverage when armed for personal protection. | |
| | (k) Weapons/Equipment Restrictions and | |
| | Responsibilities. Unless otherwise provided, the U.S. | |
| | Government will not provide any weapons or | |
| | ammunition to contractors, their subcontractors, or any | |
| | employees of the same. The Contractor will provide all | |
| | weapons and ammunition to those employees that will be | |
| | armed under the contract. The contractor and its | |
| | subcontractors at all tiers will also provide interceptor | |
| | body armor, ballistic helmets, and the Nuclear, | |
| | Biological, and Chemical (NBC) protective masks to | |
| | those employees that require such equipment in the | |
| | performance of their duties. | |
| | (1) Rules for the Use of Force (RUF). In addition to the | |
| | RUF and ROE training referenced in paragraph (c), the | |
| | contractor and its subcontractors at all tiers will monitor | |
| | and report all activities of its armed employees that may | |
| | violate the RUF and/or otherwise trigger reporting | |
| | requirements as serious incidents. Prompt reporting | |
| | demonstrates a desire by the contractor and its | |
| | subcontractors to minimize the impact of any violations | |
| | and, therefore, will be given favorable consideration. | |
| | Violations of the RUF include, though are not limited to: | |
| | (1) Taking a direct part in hostilities or combat actions, | |
| | other than to exercise self-defense; | |
| | (2) Failing to cooperate with Coalition and Host Nation | |
| | forces; | |
| | (3) Using deadly force, other than in self-defense where | |
| | there is a reasonable belief of imminent risk of death or | |
| | serious bodily harm; | |
| | (4) Failing to use a graduated force approach; | |
| | (5) Failing to treat the local civilians with humanity or | |
| | respect; and | |
| | (6) Detaining local civilians, other than in self-defense or | |
| | as reflected in the contract terms. | |
| | (m) Retention and Review of Records. The Contractor | |
| | and all subcontractors at all tiers shall maintain records | |
| | on weapons training, LOAC, RUF and the screening of | |
| | employees for at least six (6) months following the | |
| | expiration (or termination) of the contract. The | |
| | Contractor and its subcontractors at all tiers shall make | |
| | these records available to the Contracting Officer or | |
| | designated representative, at no additional cost to the | |
| | government, within 72 hours of a request. | |
| | (n) Contractor Vehicles. Vehicles used by contractor and | |
| | subcontractor personnel in the course of their security | |
| | duties shall not be painted or marked to resemble U.S./ | |
| | Coalition or host nation military and police force | |
| | vehicles. | |
| | (o) Quarterly Reporting. The prime contractor will report | |
| | quarterly (i.e. NLT 1 January, 1 April, 1 July and 1 | |
| | October for each quarter of the calendar year) to the | |
| | Contracting Officer responsible for this contract, and any | |
| | other organization designated by the Contracting Officer, | |
| | the following information under this contract: | |
| | (1) The total number of armed civilians and contractors; | |
| | (2) The names and contact information of its | |
| | subcontractors at all tiers; and | |
| | (3) A general assessment of the threat conditions, | |
| | adequacy of force numbers, and any problems that might | |
| | require a change to force levels. Note: this information is | |
| | in addition to the information the contractor promises to | |
| | immediately provide under the communications plan | |
| | referenced at paragraph (d). | |
| Clause125 | 5252.225-9520 SHIPPING INSTRUCTION FOR | NA not buying |
| | WEAPONS (JCC I/A 952.225-0008)(MARCH 2009) | weapons |
| Clause127 | 5252.225-9521 MEDICAL SCREENING AND | Q 18 |
| | VACCINATION REQUIREMENTS FOR LOCALLY | |
| | HIRED EMPLOYEES (IRAQ ONLY) (JCC-I/A | |
| | 952.225-0009)(NOVEMBER 2010) | |
| | (a) Contractors, and subcontractors at any tier shall | |
| | ensure and provide satisfactory evidence that all locally | |
| | hired employees, including Local National (LN), Third | |
| | Country National, and U.S. employees, working on | |
| | military have been screened for and do not currently have | |
| | active tuberculosis (TB). | |
| | (1) Contractors may initially utilize a testing method of | |
| | either a chest x-ray or TB skin test (TST), depending on | |
| | the originating country a contracted employee. | |
| | (i) Chest x-rays (CXR's), symptom survey, and BMI | |
| | shall be taken, and TSTs administered within 12 months | |
| | prior to the start of deployment/employment. Contractors | |
| | are required to bring in a physical copy of the pre- | |
| | employment CXR film as it is the only way to verify | |
| | interval changes should an active case of TB occur. | |
| | (A)Third Country Nationals (TCNs) and Local Nationals | |
| | (LNs) cannot be screened with the TST. They need the | |
| | pre-employment screening with a quality CXR, Body | |
| | Mass Index (BMI) and symptom survey | |
| | (B) Small-Risk Nationals (SRNs), those with less than 25 | |
| | TB cases per 100,000 persons annually (mostly expats | |
| | from Europe and US), can be screened via the TST. See | |
| | Enclosure 1, Tab T to Appendix 4 to Annex Q, to USFI- | |
| | OPORD 10-01 | |
| | (ii) Annual re-screening for TCNs, and LNs will be | |
| | performed with a CXR conducted by the Contractors | |
| | medical provider or local economy provider, who will | |
| | look for interval changes from prior CXR's and review | |
| | any changes in the symptom survey. | |
| | (iii) SRN's do not require annual TB re-screening. | |
| | However, for a TB contact investigation, a TST or | |
| | Interferon Gamma Release Assay (IGRA) is required. | |
| | (iv) For a contact investigation, all personnel with a | |
| | positive TST or IGRA will be evaluated for potential | |
| | active TB with a symptom screen, exposure history, | |
| | BMI, and CXR. All cases of suspected or confirmed | |
| | active TB must be reported to the theater Preventive | |
| | Medicine (PM) physician and/or TB Consultant as soon | |
| | as possible. TB reporting is required within 24 hours to | |
| | the PM POC. Contact tracing, and medical coding have | |
| | specific requirements per USF-I OPORD 10-1. All | |
| | Small-Risk National (SRN) contract personnel are | |
| | required to be MEDEVAC'd out of theater, at the | |
| | contractor's expense, for treatment of active TB, after | |
| | consultation with the Theater PM or TB Consultant at the | |
| | USF-I Surgeon's office. For SRN personnel, the | |
| | contractor is responsible for management and | |
| | compliance with all prescribed public health actions. | |
| | (v) Screening may be performed either by a licensed | |
| | medical provider from the local economy or by the | |
| | contractors' licensed medical staffs. Contractors shall | |
| | maintain medical screening documentation and make it | |
| | available to the Contracting Officer upon request. | |
| | (2) TB screening and documentation is a requirement | |
| | prior to receiving badges to work in the Iraq Joint | |
| | Operations Area. A copy of the TB screening | |
| | documentation shall be provided to the responsible Base | |
| | Defense Operations Center (BDOC) prior to issuance of | |
| | base access badges. | |
| | (b) Contractor employees, including subcontractors at | |
| | any tier, who work in positions where they are working | |
| | in food service, water and ice production facilities, shall | |
| | have current Typhoid and Hepatitis “A” (full series) | |
| | immunizations in accordance with the Centers for | |
| | Disease Control and Prevention guidelines (e.g. typhoid | |
| | vaccination booster is required every 2 years), in addition | |
| | to the required TB tests. The contractor medical provider | |
| | must complete a pre-placement examination to include a | |
| | stool sample test for ova and parasites, and annual | |
| | medical screening form or equivalent for food service, | |
| | ice and water production workers. | |
| | (c) Proof of individual employee vaccinations shall be | |
| | provided to the Contracting Officer and COR showing | |
| | that their employees and their subcontractor employees at | |
| | any tier have received the above vaccinations. The | |
| | contractor shall maintain their employees' vaccination | |
| | records for examination by the Contracting Officer. The | |
| | contractor shall ensure that their subcontractors at any | |
| | tier maintain their respective employees' vaccination | |
| | records for examination by the Contracting Officer. | |
| | (d) The contractor is responsible for management and | |
| | compliance with all prescribed public health actions | |
| | regarding TB in the contracted personnel. The contractor | |
| | also bears the responsibility of ensuring that adequate | |
| | health management for TB (screening/diagnosis/ | |
| | treatment/isolation) is available at the contractor's | |
| | chosen health care provider for their contracted and | |
| | subcontracted personnel. | |
| Clause128 | 5252.225-9523 CONTRACTOR HEALTH AND | |
| | SAFETY (JCC-I/A CLAUSE 952.225-0013) (FEBRUARY 2010) | |
| | 5252.227-9501 INVENTION DISCLOSURES AND | |
| | REPORTS (NAVAIR) (MAY 1998) | |
| Clause129 | 5252.227-9505 TECHNICAL DATA AND | NA by JAW |
| | COMPUTER SOFTWARE IDENTIFICATION IN | |
| | ENGINEERING CHANGE PROPOSALS (ECPs) | |
| | (NAVAIR)(AUGUST 1987) | |
| Clause130 | 5252.227-9507 NOTICE REGARDING THE | |
| | DISSEMINATION OF EXPORT-CONTROLLED | |
| | TECHNICAL DATA (NAVAIR) (OCTOBER 2005) | |
| | (a) Export of information contained herein, which | |
| | includes release to foreign nationals within the United | |
| | States, without first obtaining approval or license from | |
| | the Department of State for items controlled by the | |
| | International Traffic in Arms Regulations (ITARS), or | |
| | the Department of Commerce for items controlled by the | |
| | Export Administration Regulations (EAR), may | |
| | constitute a violation of law. | |
| | (b) For violation of export laws, the contractor, its | |
| | employees, officials or agents are subject to: | |
| | (1) Imprisonment and/or imposition of criminal fines; | |
| | and | |
| | (2) Suspension or debarment from future Government | |
| | contracting actions. | |
| | (c) The Government shall not be liable for any | |
| | unauthorized use or release of export-controlled | |
| | information, technical data or specifications in this | |
| | contract. | |
| | (d) The contractor shall include the provisions or | |
| | paragraphs (a) through (c) above in any subcontracts | |
| | awarded under this contract. | |
| Clause131 | 5252.227-9511 DISCLOSURE, USE AND | |
| | PROTECTION OF PROPRIETARY INFORMATION | |
| | (NAVAIR) (FEBRUARY 2009) | |
| Clause132 | 5252.228-9500 ADDITIONAL DEFINITIONS WITH | Q18 |
| | RESPECT TO“GROUND AND FLIGHT RISK” | |
| | CLAUSE (NAVAIR) (DECEMBER 1991) | |
| Clause133 | 5252.232-9513 INVOICING AND PAYMENT | NA |
| | (WAWF) INSTRUCTIONS (MARCH 2009) | |
| Clause134 | 5252.232-9522 TRANSPORTATION ACCOUNT | Q23-1 |
| | CODES (NAVAIR) (OCTOBER 2005) | |
| Clause135 | 5252.243-9505 ENGINEERING CHANGES | NA |
| | (NAVAIR)(OCTOBER 2005) | |
| Clause136 | 5252.245-9500 GOVERNMENT PROPERTY FOR THE | Q23-2 |
| | PERFORMANCE OF THIS CONTRACT (NAVAIR) | |
| | (FEBRUARY 2009) | |
| Clause137 | 5252.245-9509 PLACE OF DELIVERY - | |
| | GOVERNMENT FURNISHED MATERIAL (NAVAIR) | |
| | (MARCH 1999) | |
| Clause138 | 5252.246-9512 INSPECTION AND ACCEPTANCE | NA |
| | (NAVAIR) (OCTOBER 2005) | |
| Clause139 | 5252.246-9514 INSPECTION AND ACCEPTANCE OF | NA |
| | TECHNICAL DATA AND INFORMATION | |
| | (NAVAIR) (FEBRUARY 1995) | |
| Clause140 | 5252.246-9516 SPECIAL DISTRIBUTION OF DD | NA |
| | FORM 250 (NAVAIR) (OCTOBER 2005) | |
| Clause141 | 5252.246-9526 PROVISIONAL ACCEPTANCE | NA |
| | UNDER SPECIAL CONDITIONS (NAVAIR)(OCTOBER | |
| | 2005) | |
| Clause142 | 5252.247-9502 UNPACKING INSTRUCTIONS: | |
| | COMPLEX OR DELICATE EQUIPMENT (NAVAIR) | |
| | (OCTOBER 1994) | |
| | (1) The contractor shall preserve, package, pack and | |
| | mark support material as specified below and shall | |
| | contractually require same by vendors and | |
| | subcontractorsc | |
| | a. ASTM D 3951-98. Commercial packaging and | |
| | packing for immediate use.: | |
| | b. MIL-STD-2073-1D, Military Preservation Level/ | |
| | Military Packing Level A. For long term storage, surface | |
| | X-CONUS shipments. | |
| | c. MIL-STD-2073-1D, Military Preservation Level/ | |
| | Military Packing Level B. For long term storage, air X- | |
| | CONUS shipments or surface containerized X-CONUS | |
| | shipments. | |
| | d. MIL-STD-2073-1D, Military Preservation Level/ | |
| | Military Packing Level B. For long term storage, | |
| | CONUS shipments only. | |
| Clause143 | 5252.247-9505 TECHNICAL DATA AND | Q27 |
| | INFORMATION (NAVAIR) (FEBRUARY 1995) | |
| Clause144 | 5252.247-9507 PACKAGING AND MARKING OF | Q27 |
| | REPORTS (NAVAIR) (OCTOBER 2005) | |
| Clause145 | 5252.247-9508 PROHIBITED PACKING MATERIALS | Always |
| | (NAVAIR) (JUNE 1998) | |
| Clause146 | 5252.247-9509 PRESERVATION, PACKAGING, | Q23-1 |
| | PACKING AND MARKING (NAVAIR)(JULY 1998) | |
| | 5252.247-9514 TECHNICAL DATA PACKING | |
| | INSTRUCTIONS (NAVAIR) (SEPTEMBER 1999 | |
| Clause147 | 5252.247-9514 TECHNICAL DATA PACKING | |
| | INSTRUCTIONS (NAVAIR) (SEPTEMBER 1999) | |
| Clause148 | 52.246-2 INSPECTION OF SUPPLIES -- FIXED | |
| | PRICE (AUGUST 1996) | |
| Clause149 | 52.246-3 INSPECTION OF SUPPLIES -- COST- | |
| | REIMBURSEMENT (MAY 2001) | |
| Clause150 | 52.246-4 INSPECTION OF SERVICES --FIXED | |
| | PRICE (AUGUST 1996) | |
| Clause151 | 52.246-8 INSPECTION OF RESEARCH AND | |
| | DEVELOPMENT COST REIMBURSEMENT (MAY 2001) | |
| Clause152 | 5252.204-9503 EXPEDITING CONTRACT | |
| | CLOSEOUT (NAVAIR)(JANUARY 2007) | |
| Clause153 | 5252.209-9510 ORGANIZATIONA CONFLICTS OF | |
| | INTEREST (NAVAIR)(SERVICES)(MARCH 2007) | |
| Clause154 | 5252.227-9501 INVENTION DISCLOSURES AND | |
| | REPORTS (NAVAIR)(MAY 1998) | |
| Clause155 | 5252.228-9501 LIABILITY INSURANCE | |
| | (NAVAIR)(MARCH 1999) | |
| Clause156 | 52.202-1 DEFINITIONS (JULY 2004) | |
| Clause157 | 52.204-10 REPORTING SUBCONTRACT AWARDS | |
| | (SEPTEMBER 2007) | |
| Clause158 | 52.216-7 ALLOWABLE COST AND PAYMENT | |
| | (DECEMBER 2002) | |
| Clause159 | 52.222-1 NOTICE TO THE GOVERNMENT OF | |
| | LAOR DISPUTES (FEBRUARY 1997) | |
| Clause160 | 52.222-3 CONVICT LABOR (JUNE 2003) | |
| Clause161 | 52.222-19 CHILD LABOR -COOPERATION WITH | |
| | AUTHORITIES AND REMEDIES (AUGUST 2009) | |
| Clause162 | 52.252-2 CLAUSES INCORPORATED BY | |
| | REFERENCE (FEBRUARY 1998) | |
| Clause163 | 252.217-7013 GUARANTEES (DECEMBER 1991) | |
| Clause164 | 252.225-7014 PREFERENCE FOR DOMETIC | |
| | SPECIALTY METALS (JUNE 2005) - ALT I (APRIL | |
| | 2003) | |
| Clause165 | 252.227-7017 IDENTIFICATION AND ASSERTION | |
| | OF USE, RELEASE, OR DISCLOSURE | |
| | RESTRICTIONS (JUNE 1995) | |
| Clause166 | 52.227-7028 TECHNICAL DATA OR COMPUTER | |
| | SOFTWARE PREVIOUSLY DELIVERED TO THE | |
| | GOVERNMENT (JUNE 1995) | |
| Clause167 | 5252.225-9510 COMPLIANCE WITH LAWS AND | |
| | REGULATONS (JCC-I/A 952.225-0004)(JANUARY 2010) | |
| Clause168 | 52.232-22 LIMITATION OF FUNDS (APRIL 1984) | |
| Clause169 | 52.248-1 VALUE ENGINEERING (FEBRUARY 2000) | |
| Clause170 | 252.223-7006 PROHIBITION ON STORAGE AND | |
| | DISPOSAL OF TOXIC AND HAZARDOUS | |
| | MATERIALS (APRIL 1993) | |
| Clause171 | 252.228-7001 GROUND AND FLIGHT RISK (SEPTEMBER | |
| | 1996) | |
| Clause172 | 5252.225-9508 MANDATORY SHIPPING | |
| | INSTRUCTIONS (IRAQ) (JCC-I/A 952.225- | |
| | 0007)(FEBRUARY 2010) | |
| Clause173 | 952.225-0016 CONTRACTOR DEMOBILIZATION | |
| | (NOVEMBER 2010) | |

TABLE 2

| Clause | | |
|---|---|---|
| number | Clauses | Applicable Condition |
| Clause1 | 52.203-6 Restrictions on Subcontractor Sales to the | $100K |
| | Government (SEP 2006). This clause applies only if this | |
| | contract exceeds $100,000. | |
| Clause2 | 52.203-7 Anti-Kickback Procedures (JUL 1995). Buyer | $100K |
| | may withhold from sums owed Seller the amount of any | |
| | kickback paid by Seller or its subcontractors at any tier if | |
| | (a) the Contracting Officer so directs, or (b) the | |
| | Contracting Officer has offset the amount of such | |
| | kickback against money owed Buyer under the prime | |
| | contract. This clause applies only if this contract exceeds | |
| | $100,000. | |
| Clause4 | 52.203-10 Price or Fee Adjustment for Illegal or | $100K |
| | Improper Activity (JAN 1997). This clause applies only | |
| | if this contract exceeds $100,000. If the Government | |
| | reduces Buyer's price or fee for violations of the Act by | |
| | Seller or its subcontractors at any tier, Buyer may | |
| | withhold from sums owed Seller the amount of the | |
| | reduction. | |
| Clause5 | 52.203-11, Certification and Disclosure Regarding | $10K |
| | Payments to Influence Certain Federal Transactions. | |
| | This Certification states that the prospective | |
| | subcontractor has not engaged in any of the prohibited | |
| | activities set forth in these clauses except for those | |
| | disclosed on OMB Standard Form LLL, Disclosure of | |
| | Lobbying Activities. | |
| Clause6 | 52.203-12 Limitation on Payments to Influence Certain | $100K |
| | Federal Transactions (SEP 2007). This clause applies | |
| | only if this contract exceeds $100,000. Paragraph (g)(2) | |
| | is modified to read as follows: “(g)(2) Seller will | |
| | promptly submit any disclosure required (with written | |
| | notice to Insitu) directly to the PCO for the prime | |
| | contract. Insitu will identify the cognizant Government | |
| | PCO at Seller's request. Each subcontractor certification | |
| | will be retained in the subcontract file of the awarding | |
| | contractor.” | |
| Clause14 | 52.215-2 Audit and Records - Negotiation (MAR 2009). | $100K |
| | This clause applies only if this contract exceeds | |
| | $100,000 and (i) is cost-reimbursement, incentive, time- | |
| | and-materials, labor-hour, or price-redeterminable type | |
| | or any combination of these types: (ii) Seller was | |
| | required to provide cost or pricing data, or (iii) Seller is | |
| | required to furnish reports as discussed in paragraph (e) | |
| | of the referenced clause. | |
| Clause15 | 52.215-10 Cost or Pricing Data (OCT 1997). This clause | $700K |
| | applies only if this contract exceeds the threshold set | |
| | forth in FAR 15.403-4 and is not otherwise exempt. In | |
| | subparagraph (3) of paragraph (a), insert “of this | |
| | contract” after “price or cost.” In Paragraph (c), | |
| | “Contracting Officer” shall mean “Contracting Officer or | |
| | Buyer.” In Paragraphs (c)(1), (c)(1)(ii), and (c)(2)(i), | |
| | “Contracting Officer” shall mean “Contracting Officer or | |
| | Buyer.” In Subparagraph (c)(2)(i)(A), delete “to the | |
| | Contracting Officer.” In Subparagraph (c)(2)(ii)(B), | |
| | “Government” shall mean “Government or Buyer.” In | |
| | Paragraph (d), “United States” shall mean “United States | |
| | or Buyer.” | |
| Clause16 | 52.215-11 Cost or Pricing Data--Modifications Oct-97 | $700K |
| Clause17 | 52.215-12 Subcontractor Cost or Pricing Data (OCT | $700K |
| | 1997). This clause applies only if this contract exceeds | |
| | the threshold set forth in FAR 15.403-2 (currently | |
| | $700,000), and is not otherwise exempt. The certificate | |
| | required by paragraph (b) of the referenced clause shall | |
| | be modified as follows: delete “to the Contracting | |
| | Officer or the Contracting Officer's representative” and | |
| | substitute in lieu thereof “to Insitu, Inc. or Insitu's | |
| | representative (including data submitted, when | |
| | applicable, to an authorized representative of the U.S. | |
| | Government).” | |
| Clause18 | 52.215-13 Subcontractor Cost or Pricing Data-- | $700K |
| | Modifications Oct-97 | |
| Clause19 | 52.215-14 Integrity of Unit Prices (OCT 1997). This | $100K + Q: Is your |
| | clause applies except for contracts at or below $100,000; | procurement for |
| | construction or architect-engineer services under FAR | construction or architect- |
| | Part 36; utility services under FAR Part 41; services | engineer services under |
| | where supplies are not required; commercial items; and | FAR Part 36; utility |
| | petroleum products. | services under FAR Part |
| | | 41; services where |
| | | supplies are not required; |
| | | commercial items; and |
| | | petroleum products.- Yes |
| | | doesn't apply, under 100K |
| | | delete Yes and No |
| Clause20 | 52.215-15 Pension Adjustments and Asset Reversions | $700K |
| | (OCT 2004). This Clause applies to this contract if it | |
| | meets the requirements of FAR 15.408(g). | |
| Clause21 | 52.215-18 Reversion or Adjustment of Plans for Post- | $700K |
| | Retirement Benefits (PRB) Other Than Pensions (JUL | |
| | 2005). This Clause applies to this contract if it meets the | |
| | requirements of FAR 15.408(j). | |
| Clause22 | 52.215-19 Notification of Ownership Changes (OCT | $700K |
| | 1997). This Clause applies to this contract if it meets the | |
| | requirements of FAR 15.408(k). | |
| Clause23 | 52.215-21 Requirement for Cost or Pricing Data or | $700K |
| | Information Other Than Cost and Pricing Data - | |
| | Modifications (OCT 1997). This clause applies only if | |
| | this contract exceeds the threshold set forth in FAR | |
| Clause25 | 52.219-8 Utilization of Small Business Concerns (MAY | $150K |
| | 2004). | |
| Clause26 | 52.219-9 Small-Business Subcontracting Plan (APR | $650K + Q: Is the |
| | 2008). | supplier a small business |
| | This clause applies only if this contract exceeds | ? + Buyer Action submit |
| | $650,000 and Seller is not a small business concern. | SB Plan |
| | Seller shall adopt a subcontracting plan that complies | |
| | with the requirements of this clause. In addition, Seller | |
| | shall submit to Buyer, Small and Small Disadvantaged | |
| | Business and Women-Owned Small Business | |
| | Subcontracting Plan Certificate of Compliance. In | |
| | accordance with paragraph (d)(10)(iv), Seller agrees that | |
| | it will submit the ISR and/or SSR using eSRS, and, in | |
| | accordance with paragraph (d)(10)(vi), Seller agrees to | |
| | provide the prime contract number, its own DUNS | |
| | number, and the email address of the Government or | |
| | Contractor official responsible for acknowledging or | |
| | rejecting the reports, to its subcontractors with | |
| | subcontracting plans. | |
| Clause27 | 52.222-4 Contract Work Hours and Safety Standards Act - | $100K |
| | Overtime Compensation (Jul-05) | |
| Clause28 | 52.222-20 Walsh-Healey Public Contracts Act (DEC | $10K |
| | 1996). This clause applies only if this contract exceeds | |
| | $10,000. | |
| Clause29 | 52.222-21 Prohibition of Segregated Facilities (FEB | $10K |
| | 1999). | |
| Clause30 | 52.222-26 Equal Opportunity (MAR 2007). | $10K |
| Clause31 | 52.222-35 Equal Opportunity for Special Disabled | $100K |
| | Veterans, Veterans of the Vietnam Era, and Other | |
| | Eligible Veterans (SEP 2006). This clause applies only if | |
| | this contract exceeds $100,000. | |
| Clause32 | 52.222-36 Affirmative Action For Workers With | $15K |
| | Disabilities (JUN 1998). This clause applies only if this | |
| | contract exceeds $ 15,000. | |
| Clause33 | 52.222-37 Employment Reports on Special Disabled | $100K |
| | Veterans, Veterans of the Vietnam Era, and Other | |
| | Eligible Veterans (SEP 2006). This clause applies only if | |
| | this contract exceeds $100,000. | |
| Clause34 | 52.222-39 Notification of Employee Rights Concerning | $100K |
| | Payment of Union Dues or Fees (DEC 2004). | |
| Clause40 | 52.227-1 Authorization and Consent (DEC 2007) Alt 1 | $150K |
| | (Apr 1984). | |
| Clause41 | 52.227-2 Notice and Assistance Regarding Patent and | $150K |
| | Copyright Infringement (DEC 2007). A copy of each | |
| | notice sent to the Government will be sent to Buyer. | |
| Clause47 | 52.230-2 Cost Accounting Standards Oct-08 | $500K |
| Clause48 | 52.230-3 Disclosure And Consistency Of Cost | $500K |
| | Accounting Practices Oct-08 | |
| Clause49 | 52.230-6 Administration of Cost Accounting Standards | $500K |
| | (MAR 2008). Add “Buyer and the” before | |
| | CFAO in paragraph (m). This provision applies if clause | |
| | H001, H002, or H004 is included in this contract. | |
| | H001: The clause entitled “Cost Accounting Standards,” | |
| | FAR 52.230-2, excluding paragraph (b), is incorporated | |
| | herein by reference. In this clause, “Contractor” shall | |
| | mean Seller, and any reference to “disputes” or the | |
| | “Contract Disputes Act” shall mean the Disputes clause | |
| | of this contract. The version of FAR 52.230-2 | |
| | incorporated in this contract is stated in the Cost | |
| | Accounting Standards article of the Customer Contract | |
| | Requirements (CCR) incorporated in this contract. | |
| | H002: DISCLOSURE AND CONSISTENCY IN COST | |
| | ACCOUNTING PRACTICES | |
| | The clause entitled “Disclosure and Consistency in Cost | |
| | Accounting Practices,” FAR 52.230-3, excluding | |
| | paragraph (b), is incorporated herein by reference. In this | |
| | clause, “Contractor” shall mean Seller, and any reference | |
| | to “disputes” or the “Contract Disputes Act” shall mean | |
| | the Disputes clause of this contract. The version of FAR | |
| | 52.230-3 incorporated in this contract is stated in the | |
| | Cost Accounting Standards article of the Customer | |
| | Contract Requirements (CCR) incorporated in this | |
| | contract. | |
| | H004: COST ACCOUNTING STANDARDS - | |
| | EDUCATIONAL INSTITUTION | |
| | The clause entitled “Cost Accounting Standards - | |
| | Educational Institution,” FAR 52.230-5, | |
| | excluding paragraph (b), is incorporated herein by | |
| | reference. In this clause, “Contractor” shall mean Seller, | |
| | and any reference to “disputes” or the “Contract Disputes | |
| | Act” shall mean the Disputes clause of this contract. The | |
| | version of FAR 52.230-5 incorporated in this contract is | |
| | stated in the Cost Accounting Standards article of the | |
| | Customer Contract Requirements (CCR) incorporated in | |
| | this contract. | |
| Clause58 | 252.203-7001 Prohibition on Persons Convicted of Fraud | $100K |
| | or Other Defense-Contract-Related Felonies | |
| | (DEC 2008). This clause applies only if this contract | |
| | exceeds $100,000 and does not apply to the purchase of | |
| | commercial items or commercial components. | |
| | “Contractor” and “contract” are not changed in | |
| | paragraphs (a) and (b). In paragraph (e), “Government” | |
| | shall mean Government or Buyer. In paragraph (f), | |
| | “through the Buyer” is inserted after “Contracting | |
| | Officer”. Paragraph (g) is deleted and “Contracting | |
| | Officer” shall mean Contracting Officer. | |
| Clause60 | 252.211-7000 Acquisition Streamlining Dec-91 required | $1.5 Million |
| | for contracts over $1.5 million. | |
| Clause62 | 252.215-7000 Pricing Adjustments (DEC 1991). This | $650K |
| | clause applies only if this contract exceeds $650,000. | |
| Clause68 | 252.225-7004 Reporting Of Contract Performance | $550K |
| | Outside The United States And Canada - | |
| | Submission After Award (MAY 2007). The term | |
| | “Contractor” in paragraph (b) and the term “Contracting | |
| | Officer” in paragraphs (c) and (d) means “Buyer.” This | |
| | clause applies only if this contract exceeds $550,000. | |
| Clause77 | 252.226-7001 Utilization of Indian Organizations and | $500K |
| | Indian-Owned Economic Enterprises, and Native | |
| | Hawaiian Small Business Concerns Sep-04 required for | |
| | contracts over $500,000 | |
| Clause101 | 252.249-7002 Notification Of Anticipated Contract | $100K |
| | Termination Or Reduction (DEC 2006). This clause | |
| | applies only if this contact is $100,000 or more. Seller | |
| | will comply with the notice and flowdown requirements | |
| | of paragraph (d)(2) of the referenced clause. | |

TABLE 3

| Questions | Question Text | Clauses if answered YES |
|---|---|---|
| Question 1 | Does this subcontract have a period of | Clause7, Clause8 |
| | performance of more than 120 days or is | |
| | performed entirely outside the United | |
| | States ? | |
| Question 2 | Is this procurement for hardware ? | Clause12 |
| Question 3 | Does the supplier have access to classified | Clause9, Clause42 |
| | material in regards to this contract? | |
| Question 4 | Does the performance under this contract | Clause10 |
| | require the supplier to have routine | |
| | physical access to federally controlled | |
| | facility and/or routine access to federally | |
| | controlled information system? | |
| Question 5 | Is the supplier a small business ? + Buyer | Clause25, Clause64 |
| | Action submit SB Plan? | |
| Question 6 | None of the following are true: (1) a | Clause63, Clause 64 |
| | firm-fixed-price contract awarded on the | |
| | basis of adequate price competition; (2) a | |
| | fixed-price contract with economic price | |
| | adjustment awarded on the basis of | |
| | adequate price competition; (3) a firm- | |
| | fixed-price contract for the acquisition of | |
| | a commercial item, or (4) a fixed-price | |
| | contract with economic price adjustment | |
| | for the acquisition of a commercial item | |
| Question 7 | Is the supplier delivering hazardous | Clause36, Clause115 |
| | material? | |
| Question 8 | Is this subcontract for the purchase of | Clause37 |
| | “Ozone-depleting substances” as defined | |
| | in FAR 52.223-11? | |
| Question 10 | Does this procurement require ACO | Clause53 |
| | notification or consent ? | |
| Question 11 | Does this procurement involve | Clause56 |
| | international air | |
| | transportation? | |
| Question 12 | Does this procurement involve | Clause57 |
| | transportation of equipment, materials or | |
| | commodities in ocean vessels ? | |
| Question 13 | Is your procurement greater 550K and not | Clause69 |
| | for commercial items, construction, ores, | |
| | natural gases, utilities, petroleum products | |
| | and crudes, timber (logs), or subsistence? | |
| Question 14 | Does the item being procured contain | Clause70 |
| | specialty metals ? Steel- | |
| | (A) With a maximum alloy content | |
| | exceeding one or more of the following | |
| | limits: | |
| | manganese, 1.65 percent; silicon, 0.60 | |
| | percent; or copper, 0.60 percent; or | |
| | (B) Containing more than 0.25 percent of | |
| | any of the following elements: | |
| | aluminum, chromium, cobalt, columbium, | |
| | molybdenum, nickel, titanium, | |
| | tungsten, or vanadium; | |
| | (ii) Metal alloys consisting of nickel, iron- | |
| | nickel, and cobalt base alloys containing a | |
| | total of other alloying metals (except iron) | |
| | in excess of 10 percent; | |
| | (iii) Titanium and titanium alloys; or | |
| | (iv) Zirconium and zirconium base | |
| | alloys.” | |
| Question 15 | Does this contract include the purchase of | Clause73 |
| | ball or roller bearings? | |
| Question 16 | Is the subcontractors personnel authorized | Clause74 |
| | to accompany US Armed Forces deployed | |
| | outside the US in (1) Contingency | |
| | operations; (2) Humanitarian or | |
| | peacekeeping operations; (3) Other | |
| | military operations; or (4) Military | |
| | exercises designated by the Combatant | |
| | Commander ? | |
| Question 17 | Does this procurement require | Clause75 |
| | performance or travel outside the United | |
| | States, except for contracts with-(a) | |
| | Foreign governments; (b) | |
| | Representatives of foreign governments; | |
| | or (c) Foreign corporations wholly | |
| | owned by foreign governments. Not | |
| | Statutory. | |
| | Prescribed in DFARS 225.7403-2 | |
| Question 18 | Will the supplier be deploying any | Clause76, Clause118, |
| | individuals overseas during the duration | Clause119, Clause122, Clause124 |
| | of this contract? | |
| Question 19 | Is the contract related to non-commercial | Clause79 |
| | computer software? | |
| Question 20 | Is the contract related to commercial | Clause88 |
| | products? | |
| Question 21 | Is the sub-contract greater than $50M in | Clause92 |
| | value? | |
| Question 22 | Is this procurement involving | Clause93 |
| | development, test, or operation of a | |
| | device for which a frequency | |
| | authorization is required? | |
| Question 23 | Does the contract involve proprietary | Clause95, Clause131, Clause |
| | information? | 143 |
| Question 24 | Is the supplier in the United States Forces - | Clause 114, Clause120, |
| | Iraq or the United States Forces - | Clause127 |
| | Afghanistan theater of operations? | |
| Question 26 | Does the contract involve complex or | Clause131, Clause142, |
| | delicate equipment? | Clause133 |
| Question 28 | Do any of the following apply: (ii) Seller | Clause14 |
| | was required to provide cost or pricing | |
| | data, or (iii) Seller is required to furnish | |
| | reports as discussed in paragraph (e) of | |
| | the referenced clause. | |
| Question 29 | Is your procurement for construction or | Clause19 |
| | architect-engineer services under FAR | |
| | Part 36; utility services under FAR Part | |
| | 41; services where supplies are not | |
| | required; commercial items; and | |
| | petroleum products? | |

What is claimed is:

1. A method, comprising:
determining, based on a first set of data identifying a governmental contract, a plurality of contract clauses that are applicable to the governmental contract, wherein the first set of data is received from a user;
receiving, from the user, a second set of data identifying parameters of at least one of a sub-contract and purchase order under the governmental contract, wherein the second set of data comprises one or more of a purchase order number, a value of the sub-contract, and a supplier name for the purchase order;
determining, based on the second set of data, a first set of contract clauses from the plurality of the contract clauses that are applicable to the at least one of a sub-contract and purchase order;
determining, by one or more processors based on the first set of contract clauses, one or more questions for the user, wherein the one or more questions determine an applicability of one or more contract clauses in the first set of contract clauses;
determining, based on answers to the one or more questions, a list of contract clauses from the first set of contract clauses; and
providing, to the user, the list of contract clauses for the at least one of a sub-contract and purchase order.

2. The method of claim 1, the method further comprising:
retrieving, via a network, the plurality of contract clauses from a public repository.

3. The method of claim 1, the method further comprising:
determining a risk value for at least one contract clause in the list of contract clauses, wherein the risk value represents a risk associated with the at least one contract clause;
determining, for the at least one contract clause, one or more terms or conditions that mitigates the risk for the at least one contract clause; and
providing the one or more terms or conditions to the user.

4. The method of claim 3, wherein determining the risk value for at least one contract clause comprises:
determining a base risk score for the at least one contract clause;
determining a weighting factor based on factors associated with the at least one of a sub-contract and purchase order; and
applying the weighting factor to the base risk score to determine the risk value.

5. The method of claim 3, the method further comprising:
determining, based at least partially on the risk value for at least one contract clause, an overall risk for the at least one of a sub-contract and purchase order.

6. The method of claim 1, the method further comprising:
parsing at least one contract clause in the list of contract clauses;
determining, based at least partially on the parsing, a delivery timeframe associated with the at least one contract clause;
determining an expected delivery date based at least partially on the delivery timeframe and a start date of the at least one of a sub-contract and purchase order; and
providing, to the user, a schedule that includes the expected delivery date.

7. The method of claim 1, wherein determining, based on the second set of data, the first set of contract clauses comprises:
comparing the second set of data to conditions associated with the plurality of contract clauses;
determining, based on the comparison, that one or more of the plurality of contract clauses satisfy the conditions; and
selecting the one or more of the plurality of contract clauses as the first set of contract clauses.

8. The method of claim 1, wherein determining, based on answers to the one or more questions, the list of contract clauses, comprises:
determining that an answer to a first question is negative; and
removing a first contract clause from the first set of contract clauses that corresponds to the first question.

9. The method of claim 1, the method further comprising:
determining an update to one or more of the plurality of contract clauses; and
updating one or more of the questions based on the update to one or more of the plurality of contract clauses.

10. The method of claim 1, wherein determining the one or more questions comprises:
parsing at least one contract clause from the first set of contract clauses;
identifying, based at least partially on the parsing, one or more terms that are associated with an applicability of the at least one contract clause; and
generating at least one of the one or more questions based at least partially on the one or more terms.

11. A system, comprising:
one or more memory devices storing instructions; and
one or more processors coupled to the one or more memory devices and configured to execute the instructions to perform a method comprising:
determining, based on a first set of data identifying a governmental contract, a plurality of contract clauses that are applicable to the governmental contract, wherein the first set of data is received from a user;
receiving, from the user, a second set of data identifying parameters of at least one of a sub-contract and purchase order under the governmental contract, wherein the second set of data comprises one or more of a purchase order number, a value of the sub-contract, and a supplier name for the purchase order;
determining, based on the second set of data, a first set of contract clauses from the plurality of the contract clauses that are applicable to the at least one of a sub-contract and purchase order;
determining, by one or more processors based on the first set of contract clauses, one or more questions for the user, wherein the one or more questions determine an applicability of one or more contract clauses in the first set of contract clauses;
determining, based on answers to the one or more questions, a list of contract clauses from the first set of contract clauses; and
providing, to the user, the list of contract clauses for the at least one of a sub-contract and purchase order.

12. The system of claim 11, the system further comprising:
a network interface to a network, wherein the plurality of contract clauses are retrieved from a public repository coupled to the network.

13. The system of claim 11, wherein the one or more processors are configured to execute the instructions to perform the method further comprising:
determining a risk value for at least one contract clause in the list of contract clauses, wherein the risk value represents a risk associated with the at least one contract clause;
determining, for the at least one contract clause, one or more terms or conditions that mitigates the risk for the at least one contract clause; and
providing the one or more terms or conditions to the user.

14. The system of claim 11, wherein determining, based on the second set of data, the first set of contract clauses comprises:
comparing the second set of data to conditions associated with the plurality of contract clauses;
determining, based on the comparison, that one or more of the plurality of contract clauses satisfy the conditions; and
selecting the one or more of the plurality of contract clauses as the first set of contract clauses.

15. The system of claim 11, wherein determining, based on answers to the one or more questions, the list of contract clauses, comprises:
determining that an answer to a first question is negative; and
removing a first contract clause from the first set of contract clauses that corresponds to the first question.

16. The system of claim 11, wherein determining the one or more questions for the user comprises:
parsing at least one contract clause from the first set of contract clauses;
identifying, based at least partially on the parsing, one or more terms that are associated with an applicability of the at least one contract clause; and
generating at least one of the one or more questions based at least partially on the one or more terms.

17. A non-transitory computer readable medium storing instructions for causing one or more processors to perform a method, the method comprising:
determining, based on a first set of data identifying a contract, a plurality of contract clauses that are applicable to the contract, wherein the first set of data is received from a user;
receiving, from the user, a second set of data identifying parameters of at least one of a sub-contract and purchase order under the contract;
determining, based on the second set of data, a first set of contract clauses from the plurality of the contract clauses that are applicable to the at least one of a sub-contract and purchase order;
determining, based on the first set of contract clauses, one or more questions for the user, wherein the one or more questions determine an applicability of one or more contract clauses in the first set of contract clauses;
determining, based on answers to the one or more questions, a list of contract clauses from the first set of contract clauses; and
providing, to the user, the list of contract clauses for the at least one of a sub-contract and purchase order.

18. The non-transitory computer readable medium of claim 17, the method further comprising:
determining a risk value for at least one contract clause in the list of contract clauses, wherein the risk value represents a risk associated with the at least one contract clause;
determining, for the at least one contract clause, one or more terms or conditions that mitigates the risk for the at least one contract clause; and
providing the one or more terms or conditions to the user.

19. The non-transitory computer readable medium of claim 17, wherein determining, based on the second set of data, the first set of contract clauses comprises:
comparing the second set of data to conditions associated with the plurality of contract clauses;
determining, based on the comparison, that one or more of the plurality of contract clauses satisfy the conditions; and
selecting the one or more of the plurality of contract clauses as the first set of contract clauses.

20. The non-transitory computer readable medium of claim 17, wherein determining, based on answers to the one or more questions, the list of contract clauses, comprises:
determining that an answer to a first question is negative; and
removing a first contract clause from the first set of contract clauses that corresponds to the first question.
